(19) United States
(12) Patent Application Publication
(10) Pub. No.: US 2025/0238026 A1
(43) Pub. Date: Jul. 24, 2025

(54) DISTRIBUTED ADAPTIVE BUILDING MONITORING AND CONTROL SYSTEM

(71) Applicant: UBX Systems, Inc., Portland, OR (US)

(72) Inventors: Jonah PESKIN, Hood River, OR (US); Patrick J. NYSTROM, Corbett, OR (US); Salvatore D'AURIA, Mt. Hood, OR (US)

(21) Appl. No.: 19/033,254

(22) Filed: Jan. 21, 2025

Related U.S. Application Data
(60) Provisional application No. 63/622,339, filed on Jan. 18, 2024.
(60) Provisional application No. 63/622,354, filed on Jan. 18, 2024.
(60) Provisional application No. 63/622,391, filed on Jan. 18, 2024.

(51) Int. Cl. G05B 19/418; H04W 4/38

(52) U.S. Cl. CPC G05B 19/4186; H04W 4/38

(57) ABSTRACT

The implementations herein are generally directed to modular and distributed wireless monitoring and control systems for building automation networks (BAS/BMS). The disclosed systems address limitations of existing systems by utilizing a wireless network of nodes within a building to monitor parameters and control equipment. The system employs a long-range wireless area network (LoRaWAN) for communication, enabling low-power, long-range data transmission. Devices not natively configured for LoRaWAN can be integrated using smart adapters that translate between LoRaWAN and the devices' native protocols. The systems may be configured communicate with remote computing systems for data analysis, control logic updates, and integration with external data sources such as weather information.

### RELATED APPLICATIONS

The present application claims the benefit under 35 U.S.C. § 119 (e) of U.S. Provisional Application No. 63/622,339, filed Jan. 18, 2024, U.S. Provisional Application No. 63/622,354, filed Jan. 18, 2024, and U.S. Provisional Application No. 63/622,391, filed Jan. 18, 2024, each of which is hereby incorporated herein by reference in its entirety under 37 C.F.R. § 1.57. Any and all applications for which a foreign or domestic priority claim is identified in the Application Data Sheet as filed with the present application are hereby incorporated by reference under 37 C.F.R. § 1.57.

### BACKGROUND

Traditional building automation networks (Building Automation System or Building Management System (BAS/BMS)) are built using wired connections (e.g., Ethernet or RS485) utilizing standardized protocols (e.g., Modbus or BACnet) to connect all equipment. One or more central building controller(s), which can be networked together or operated independently as subsystems, control equipment according to configured time schedules and other custom logic to coordinate all equipment that must operate in synchrony.

Wired networks offer high bandwidth and high reliability links between all nodes, which enables a simpler, centralized control logic architecture. However, they carry a high cost to install the wires to all equipment, control systems, and sensors. Many devices connected to a BAS/BMS do not have wireless capabilities and are prohibitively expensive to replace with wireless-capable devices. Furthermore, even to the extent that wireless capabilities are available, coordinating all the devices that may exist within a BAS/BMS is challenging and often unreliable.

Some equipment in a building can have native logic configuration capabilities that enable a user to define control logic for the equipment. For example, an air conditioning system can be configured with logic that causes the air conditioning system to turn on if temperature in a room rises above a specified threshold and to turn off when the temperature falls below another specified threshold. However, any updates to the logic applied by these systems typically must be updated at the system and are therefore inconvenient to manage. On the other hand, when these types of equipment are linked to a BAS or BMS to centralize their management with other systems in the building, logic defined at the equipment may conflict with control signals from the building's centralized BAS/BMS. Thus, the internal equipment logic sometimes needs to be disabled for the equipment to operate within the overall management scheme for the building.

As a further challenge to existing BASs and BMSs, some buildings have multiple tenants that operate independently and do not wish to share building operation data with one another. If building operation data is transmitted over an Internet protocol-based network, a building manager typically needs to configure virtual private networks for each tenant to provide security for transmission of each tenant's building operation data to the centralized control system for the building. It also can be difficult for each tenant to configure building management rules within their occupied space when the building operations are centrally managed.

### BRIEF DESCRIPTION OF THE DRAWINGS

Detailed descriptions of implementations of the present invention will be described and explained through the use of the accompanying drawings.

FIG. 1 illustrates an example environment in which a modular, low-power monitoring and control system operates according to some implementations herein.

FIG. 2 illustrates a block diagram of some implementations of a wireless adaptive management system according to some implementations herein.

FIG. 3 is a block diagram illustrating example components of a smart adapter, according to some implementations herein.

FIG. 4 is an example floorplan diagram that may be used as an input to an artificial intelligence and/or machine learning model according to some implementations herein.

FIG. 5 is an example flowchart of a process building management using a model according to some implementations herein.

FIG. 6 is a block diagram showing some of the components typically incorporated in at least some of the computer systems and other devices on which the disclosed system operates in accordance with some implementations herein.

FIG. 7 is a system diagram illustrating an example of a computing environment in which the disclosed system operates in some implementations herein.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### SUMMARY

For purposes of this summary, certain aspects, advantages, and novel features of the invention are described herein. It is to be understood that not all such advantages necessarily may be achieved in accordance with any particular implementation of the invention. Thus, for example, those skilled in the art will recognize that the invention may be embodied or carried out in a manner that achieves one advantage or group of advantages as taught herein without necessarily achieving other advantages as may be taught or suggested herein.

The implementations herein are generally directed to a modular and distributed wireless monitoring and control system comprising: a plurality of network nodes, each network node comprising: a piece of environmental equipment, the piece of environmental equipment configured to change one or more parameters of an environment or of the piece of environmental equipment; one or more sensors configured to measure the one or more parameters; or one or more smart adapters coupled to the piece of environmental equipment or at least one of the one or more sensors, wherein each smart adapter of the one or more smart adapters comprises: at least one hardware processor; and at least one non-transitory memory storing instructions, which, when executed by the at least one hardware processor, cause the smart adapter to: receive, from the piece of environmental equipment or the at least one of the one or more sensors, an equipment protocol communication comprising the one or more parameters; and translate the equipment protocol communication into a format capable of being transmitted via a first communication link; and one or more gateways in operable communication with the plurality of network nodes, wherein the operable communication occurs via a first communication link to transmit the one or more parameters from the plurality of network nodes to the one or gateways, wherein the first communication link comprises a physical layer and a communication protocol associated with the physical layer, and wherein the one or more gateways are in second operable communication with one or more remote computing systems via a second communication link.

In some implementations, the physical layer of the first communication link comprises radio signals. In some implementations, the radio signals are formatted using chirp pulses to encode the one or more environmental parameters. In some implementations, the physical layer of the first communication link comprises long range radio (LoRa). In some implementations, the communication protocol comprises a long-range wireless area network (LoRaWAN).

In some implementations, each node of the plurality of nodes is in operable communication with more than one of the one or more gateways via the first communication link. In some implementations, the second communication link comprises Ethernet, satellite, mobile broadband, or Wi-Fi. In some implementations, the environment comprises a building, a room within a building, a floor within a building, a building complex, or a neighborhood with multiple buildings or groups of buildings.

In some implementations, the one or more sensors are located within or connected to the at least one piece of environmental equipment. In some implementations, the one or more sensors distributed throughout the environment. In some implementations, the one or more sensors comprise temperature sensors, pressure sensors, humidity sensors, carbon dioxide sensors, volatile organic compound sensors, particulate matter sensors, air velocity sensors, accelerometers, or light detectors.

In some implementations, the one or more smart adapters are physically coupled to the piece of environmental equipment or at least one of the one or more sensors via a wired connection. In some implementations, the one or more smart adapters are coupled to the piece of environmental equipment or at least one of the one or more sensors via Bluetooth, Wi-Fi, Zigbee, Thread or ultra-wideband (UWB). In some implementations, the smart adapter is further caused to implement one or more control protocols to generate and transmit instructions to the piece of environmental equipment to change one or more parameters of an environment or of the piece of environmental equipment. In some implementations, the smart adapter is further caused to intercept and buffer commands received from the one or more remote computing systems.

In some implementations, the system further comprises a central controller, the central controller comprises at least one hardware processor; and at least one non-transitory memory storing instructions, which, when executed by the at least one hardware processor, cause the central controller to: receive or generate instructions to change the one or more parameters; and transmit the instructions at least one of the plurality of nodes. In some implementations, the central controller is integrated into the one or more gateways, communicatively coupled to the one or more gateways, or divided between the one or more gateways and/or the one or more remote computing systems.

In some implementations, each network node further comprises: at least one hardware processor; and at least one non-transitory memory storing instructions, which, when executed by the at least one hardware processor, cause the network node to: receive or generate instructions to change the one or more parameters. In some implementations, the modular and distributed wireless monitoring and control system of claim 18, wherein the network node comprises the piece of environmental equipment and wherein the piece of environmental equipment is further caused to change the one or more parameters. The modular and distributed wireless monitoring and control system of claim 18, wherein the network node is further caused verify whether a link to another network node of the plurality of network nodes is active.

Some implementations herein are directed to a smart adapter device configured to interface with and control a system device in an environment, the smart device comprising: wired communication circuitry comprising a physical interface between the smart adapter device and the system device, the physical interface configured to transfer system device operation data between the smart adapter device and the system device; a power switching circuit configured to draw power from the system device to power the smart adapter device; at least one programmable circuit; and at least one non-transitory memory storing instructions, which, when executed by the at least one programmable circuit, cause the smart adapter to: determine a network configuration of the system device by cycling through a plurality of network configuration modes; poll, from the system device via the physical interface, a plurality of registers to determine an identity of the system device; configure control logic for the system device based on the determined identity of the system device; receive, from the system device via the physical interface, the system device operation data, wherein the system device operation data comprises at least one parameter of the system device, and wherein the system device operation data is sampled based on a sampling rate configuration stored in the at least one non-transitory memory; generate a control signal by processing the system device operation data using control logic stored in the at least one non-transitory memory; and transmit, to the system device via the physical interface, the control signal, wherein the control signal is configured to cause the system device to change the at least one parameter.

In some implementations, the smart adapter further comprises wireless communication circuitry configured to transfer system data between the smart adapter device and the system via a wireless communication link. In some implementations, the smart adapter device is configured to receive system data and/or external data from a remote computing system via the wireless communication circuitry.

In some implementations, the at least one programmable circuit comprises a processor comprises a central processing unit (CPU). In some implementations, the at least one programmable circuit comprises an application-specific integrated circuit (ASIC), programmable logic device (PLD), field-programmable gate array (FPGA), tensor processing unit (TPU), neural processing unit (NPU), or vision processing units (VPU).

In some implementations, the smart adapter is further caused to broadcast the determined identity of the system to other devices in the environment or to a remote computing system.

In some implementations, the smart adapter further comprises at least one sensor, wherein the smart adapter is further caused to process measurements from the at least one sensor to detect a fault in the system device. In some implementations, the smart adapter is further caused to, in response to detection of the fault in the system device, generate signals to power cycle the system device or reset software of the system device.

In some implementations, the smart adapter is further caused to generate at least one derived parameter from the system device operation data. In some implementations, the smart adapter is further caused to: transmit, to a remote computing system via wireless communication circuitry, the system device operation data; receive, from the remote computing system via the wireless communication circuitry, an externally generated control signal; and transmit, to the system device via the wired communication circuitry, the externally generated control signal.

In some implementations, the smart adapter is further caused to receive the control logic from another system device in the environment, another smart adapter in the environment, a central controller in the environment, or a remote computing system.

In some implementations, the control logic comprises adaptive control logic, such that the smart adapter is further caused to: identify, from the system device operation data, at least one relevant parameter that, when adjusted, is determined by the smart adapter to achieve a specific result by the system device; and updating the control logic based on the identified relevant parameter. In some implementations, the control logic comprises adaptive control logic, such that the smart adapter is further caused to: identify, from the system device operation data, at least one relevant parameter that, when adjusted, is determined by the smart adapter to achieve a specific result by another system device within the environment; and updating the control logic based on the identified relevant parameter.

In some implementations, the smart adapter is further caused to: store, in the at least one non-transitory memory, the system device operation data; store, in the at least one non-transitory memory, environmental data comprising at least one parameter of the environment; and derive, based on the system device operation data and the environmental data, updated control logic.

In some implementations, the system device operation data is received from the system device in a first format, wherein the first format is incompatible with wireless transmission via a wireless network, and wherein the smart adapter is further caused to translate the system device operation data into a second format, wherein the second format is compatible with wireless transmission. In some implementations, the wireless network comprises a long-range wireless area network (LoRaWAN).

In some implementations, the smart adapter is further caused to: buffer the system device operation data in the at least one in the at least one non-transitory memory; and transmit, based on satisfaction of pre-determined criteria, the system device operation data to a remote computing system. In some implementations, the sampling rate configuration is automatically adjusted by the smart adapter based on at least one environmental parameter. In some implementations, the automatic adjustment of the sampling rate configuration comprises: causing an increase or decrease in a sampling rate of the smart adapter from the system device; causing an increase or decrease in the precision of the system device operation data received from the system device; generating and transmitting a control signal, by the smart adapter, that instructs the system device to adjust a frequency of transmission of the system device operation data; or downsampling the system device operation data. In some implementations, the at least one environmental parameter comprises network bandwidth.

Some implementations herein are directed to a system comprising: at least one hardware processor; and at least one non-transitory memory storing instructions, which, when executed by the at least one hardware processor, cause the system to: train a machine learning model using a training dataset comprising a plurality of building floorplans to generate a trained model, wherein the machine learning model comprises a multi-modal large language model (LLM); receive, via a user interface, static environment data related to an environment; generate, by the system, a combined representation of the environment based on the received static environment data, wherein the combined representation of the environment is configured to be inputted to the trained model as a knowledge base; receive, via a network of nodes distributed within the environment, real-time environment data; receive, via the user interface or via automatic generation, a prompt related to the environment; generate, using the trained model, a response to the prompt; and display, via the user interface, the response.

In some implementations, the LLM comprises Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), BigScience Large Open-science Open-access Multilingual Language Model (BLOOM), Text-to-Text Transfer Transformer (T5), Robustly Optimized BERT Pretraining Approach (RoBERTa), XLNet, A Lite BERT (ALBERT), DistilBERT, Enhanced Representation through Knowledge Integration (ERNIE), Turing-NLG, or Mistral.

In some implementations, the LLM is locally hosted by a computing system within the environment. In some implementations, the LLM is managed by a remote computing system outside of the environment.

In some implementations, the static environment data comprises at least a floorplan of the environment. In some implementations, the static environment data comprises user annotations of elements within the environment. In some implementations, the static environment data further comprises user-defined relationships between elements within the environment. In some implementations, the relationships comprise at least one of: parent-child relationships, sibling relationships, source-destination relationships, and/or input-output relationships. In some implementations, the system is further caused to analyze the static environment data to automatically determine relationships between the elements within the environment. In some implementations, the static environment data comprises at least one of the following: element names, element types, element locations, element manufacturers, element, models, element characteristics, and/or element categorizations.

In some implementations, the real-time environment data comprises at least current state information for at least one element within the environment.

In some implementations, the environment comprises a building.

In some implementations, the static environment data comprises at least one image of an element within the environment.

Some implementations herein are directed to a non-transitory, computer-readable storage medium comprising instructions recorded thereon, wherein the instructions when executed by at least one data processor of a system, cause the system to: train a machine learning model using a training dataset comprising a plurality of building floorplans to generate a trained model, wherein the machine learning model comprises a multi-modal large language model (LLM); receive, via a user interface, static environment data related to an environment; generate, by the system, a combined representation of the environment based on the received static environment data, wherein the combined representation of the environment is configured to be inputted to the trained model as a knowledge base; receive, via a network of nodes distributed within the environment, real-time environment data; receive, via the user interface or via automatic generation, a prompt related to the environment; generate, using the trained model, a response to the prompt; and display, via the user interface, the response.

Some implementations herein are directed to a computer implemented method for static and real-time analysis of an environment, the computer implemented method comprising: training a machine learning model using a training dataset comprising a plurality of building floorplans to generate a trained model, wherein the machine learning model comprises a multi-modal large language model (LLM); receiving, via a user interface, static environment data related to the environment; generating, by the system, a combined representation of the environment based on the received static environment data, wherein the combined representation of the environment is configured to be inputted to the trained model as a knowledge base; receiving, via a network of nodes distributed within the environment, real-time environment data; receiving, via the user interface or via automatic generation, a prompt related to the environment; generating, using the trained model, a response to the prompt; and displaying, via the user interface, the response.

In some implementations, the LLM is locally hosted by a computing system within the environment. In some implementations, the LLM is managed by a remote computing system outside of the environment. In some implementations, the static environment data comprises at least a floorplan of the environment. In some implementations, the static environment data comprises user annotations of elements within the environment. In some implementations, the static environment data further comprises user-defined relationships between elements within the environment.

Some implementations herein are directed to a non-transitory, computer-readable storage medium comprising instructions recorded thereon, wherein the instructions when executed by at least one data processor of a system, cause the system to: receive, from a node of the plurality of nodes, an equipment protocol communication comprising one or more parameters of an environment or of the piece of environmental equipment, wherein the node comprises a piece of environmental equipment; translate the equipment protocol communication into a format capable of being transmitted via a first communication link; and transmit, to one or more gateways in operable communication with the computer system via a first communication link, the translated equipment protocol communication, wherein the first communication link comprises a physical layer and a communication protocol associated with the physical layer, and wherein the one or more gateways are in second operable communication with one or more remote computing systems via a second communication link, wherein the system comprises a smart adapter coupled to the piece of environmental equipment.

Some implementations herein are directed to a computer implemented method for wireless monitoring and control of a plurality of nodes in an environment, the computer implemented method comprising: receiving, by a computer system from a node of the plurality of nodes, an equipment protocol communication comprising one or more parameters of an environment or of the piece of environmental equipment, wherein the node comprises a piece of environmental equipment; translating, by the computer system, the equipment protocol communication into a format capable of being transmitted via a first communication link; and transmitting, from the computer system to one or more gateways in operable communication with the computer system via a first communication link, the translated equipment protocol communication, wherein the first communication link comprises a physical layer and a communication protocol associated with the physical layer, and wherein the one or more gateways are in second operable communication with one or more remote computing systems via a second communication link, wherein the computer system comprises a smart adapter coupled to the piece of environmental equipment, and wherein the computer system comprises a processor and a memory.

### DETAILED DESCRIPTION

### Introduction

Although certain preferred implementations and examples are disclosed below, inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

To solve the problems with existing BAS/BMS, a modular and distributed wireless monitoring and control system is provided herein. The system described herein may comprise a wireless network of nodes in an environment (e.g., building, floor, site, etc.) that communicate with each other in order to monitor parameters in the environment and to control equipment based on the monitored parameters. In some implementations, the wireless network in the environment includes a long-range wireless area network (LoRaWAN), which employs the long-range, low-power, and low-bandwidth communication protocol long range radio (LoRa).

The Internet of Things (IoT) includes various technology and solutions that allow physical devices, vehicles, appliances, and other objects embedded with sensors, software, and/or network connectivity to collect and share data. One of the key challenges in building out the IoT is ensuring that those “things” or end nodes are to communicate with the Internet. Furthermore, nodes need to run on some sort of battery power, have weak radios, and are limited in memory and processing power, which limits communication options. For example, Wi-Fi is common but uses a significant amount of energy and transmits relatively large amounts of data, such that Wi-Fi is not a good solution for IoT devices that do not have as much energy at their disposal or wish to send small amounts of data. There are also limitations in the modulation techniques available in the Wi-Fi protocol and as such access points can only handle a few nodes/devices simultaneously. While Bluetooth devices allow local communication, Bluetooth has very limited range and requires too much power for most devices/nodes.

LoRa is a wireless protocol that encodes information on radio waves using chirp pulses and is designed specifically for long-range, low-power communications. LoRa operates by connecting a plurality of devices/nodes to one or more concentrators or “gateways” that can communicate with remote computing systems such as network servers and application servers, among others. Each LoRa gateway can handle up to millions of nodes. Furthermore, the communication signals can span a significant distance (e.g., up to 15 Km), which means that there is less infrastructure required, making constructing a network much cheaper and faster to implement than other protocols. LoRa also features an adaptive data rate algorithm to help maximize node battery life and network capacity. The LoRa protocol includes several different layers including encryption at the network, application, and device level for secure communications. LoRaWAN is a Media Access Control (MAC) layer protocol built on top of LoRa modulation. LoRaWAN is a software layer which defines how devices use the LoRa hardware, for example when they transmit, and the format of messages.

In some implementations, any node/device in an environment that is configured for LoRaWAN communication can be added to the network and integrated into a synchronized control scheme for the environment. For devices that are not natively configured for LoRaWAN, smart adapters can be coupled to the devices to translate between LoRaWAN and the native communication protocols of the devices. In some implementations, the network can further incorporate components such as gateways or routers to facilitate network communications within the environment or with remote (e.g., cloud-based) systems. Control of environment systems can be distributed across different levels of nodes of the environment in order to ensure reliability of the environment's operations under a variety of conditions.

In some implementations, network nodes are not associated with a specific gateway. Instead, data transmitted by a node is typically received by multiple gateways. Each gateway will forward the received packet from the end-node to the cloud-based network server via a second communication link (e.g., cellular, Ethernet, satellite, or Wi-Fi). In some implementations, the processing of parameters is performed via the network server, which manages the network and may filter redundant received packets, perform security checks, schedule acknowledgments through the optimal gateway, and perform adaptive data rate changes, etc. If a node is mobile or moving there is no handover needed from gateway to gateway, which is a critical feature to enable asset tracking applications.

In some implementations, the nodes of the network are asynchronous and communicate when they have data ready to send, whether event-driven or scheduled. In a typical mesh network or with a synchronous network, such as cellular, the nodes frequently must ‘wake up’ to synchronize with the network and check for messages. This synchronization consumes significant energy.

As used herein, a “node” refers to any device capable of sending or receiving data, including any data source, intermediary device, and/or end device within a wired or wireless network. A “node” may comprise equipment, sensors, adapters, or any other device present in each environment. As used herein, a “gateway” refers to any device that communicates with nodes and remote computing devices. Gateways may communicate with remote computing devices via a communication link, such as Ethernet, satellite, or Wi-Fi.

### Wireless Building Network

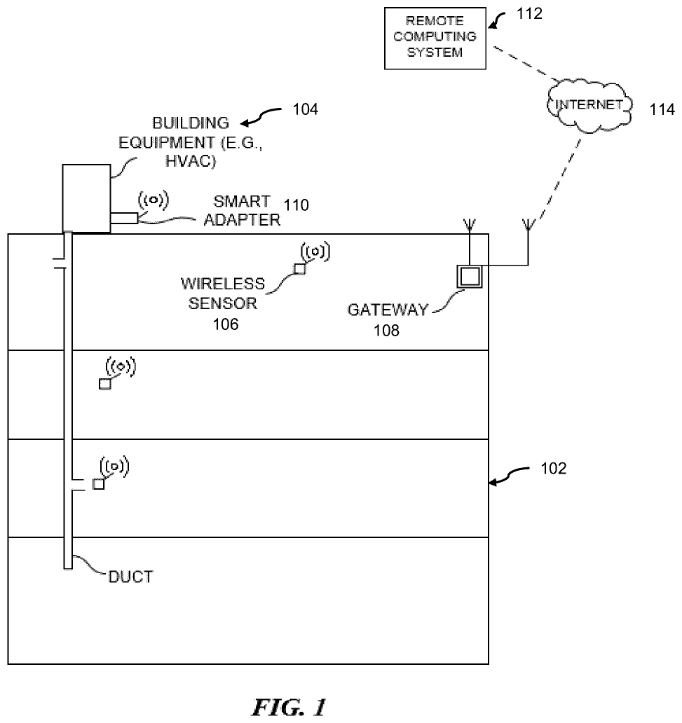

FIG. 1 illustrates an example environment in which a modular, low-power monitoring and control system 100 operates according to some implementations herein. To illustrate the wireless monitoring and control system 100, FIG. 1 depicts a building 102 as an example environment in which the monitoring and control system 100 operates. However, similar systems can be implemented in environments both smaller and larger than a building, such as a room within a building, an office complex, or a neighborhood with multiple buildings or groups of buildings, among others. As illustrated in FIG. 1, the environment includes building system equipment 104, sensors 106, a gateway 108, and/or smart adapters 110. In some implementations, the various components of the wireless monitoring and control system 100 may be connected to one or more remote computing systems 112 via communication link, such as the Internet 114, through gateway 108.

In some implementations, a building 102 can have one or more building systems that regulate a parameter(s) inside the building, the one or more building systems comprising building equipment 104. Example building systems include heating, ventilation, air conditioning, humidifying/dehumidifying, lighting, or fire suppression systems, among others. Associated with each building system is building equipment 104 that operate independently or in conjunction with other components of the system to regulate a corresponding parameter. The building system equipment 104 can be controlled to turn on, turn off, or change an operating parameter based at least in part on measurements of the building environment by sensors 106. FIG. 1 illustrates an example HVAC system, which supplies air to several rooms or floors in the building via one or more ducts.

Sensors 106 can be distributed throughout the building 102 or within building system equipment 104 to measure respective parameters in the building 102 or equipment 104. Example sensors 106 include temperature sensors, pressure sensors, humidity sensors, carbon dioxide sensors, volatile organic compound sensors, particulate matter sensors, air velocity sensors, accelerometers, light detectors, or any other sensor that can measure a physical property of an environment or system.

In some implementations, at least some of the building system equipment 104 or sensors 106 are configured for wireless communication on a wireless network. In some implementations, a long-range wireless area network (LoRaWAN) facilitates communication to, from, and/or between equipment 104 and sensors 106 in a building. LoRaWAN represents a communication protocol and system architecture in which devices communicate via LoRa, a spread spectrum modulation technique that enables long-range, low-power communication over an unlicensed radio frequency spectrum. The protocol employs a star or star-of-stars topology, where end devices communicate with nearby gateways 108, which in turn relay data to a central network server such as the one or more remote computer systems 112. Data transmitted via LoRa may be end-to-end encrypted, for example via AES-128 encryption.

One or more LoRaWAN gateways 108 can be placed in or near a building to handle communications to or from equipment 104 or sensors 106 in the building. In some implementations, a gateway 108 receives radio frequency data packets transmitted by LoRaWAN modules in equipment 104 or sensors 106 and sends data packets to LoRaWAN modules. Since LoRa is a long-range communication protocol, one gateway 108 is typically sufficient to communicate with end devices located anywhere in a large building. A gateway 108 can also be shared between buildings.

As noted above, in addition to communicating with wireless devices via the LoRaWAN network in a building 102, some implementations of the LoRaWAN gateway 108 can be configured to communicate with a remote computing system 112 via a higher-bandwidth type of communication, such as Internet protocol-based communication (e.g., Ethernet or Wi-Fi) 114 or mobile broadband communication (e.g., 4G or 5G). The gateway 108 can transmit information about the operation of the building to the remote computing system 112 and receive updated logic or instructions from the remote computing system 112 for implementation in the building 102. Some parameters that affect operation of the building 102 can also be received from the remote computing system 112 in some implementations. For example, the gateway 108 receives weather data from the remote computing system 112 and adapts temperature, humidity, or ventilation within the building 102 based on the weather outside the building 102.

In some implementations, the gateway 108 can be configured to store or process data received from building sensors 106 or equipment 104 or from the remote computing system 112. Data processing by the gateway 108 can include, for example, processing updated logic received from the remote computing system 112 to transmit to other nodes in the building network (e.g., to cause the nodes to update a building schedule) or performing aggregation or transformation of the data to configure it for transmission to the remote computing system 112 for alerts, aggregation, or analysis. Furthermore, in some implementations, the gateway 108 can implement at least some of the control logic described herein, instead of or in addition to this logic being implemented at lower-level nodes in the building network.

LoRa is a low-bandwidth communication protocol, with data rates on a LoRaWAN channel range from about 0.3 kbit/s to about 50 kbit/s. LoRa also can have lower reliability than other types of communication, and, since it transmits on unlicensed spectrum that may be shared by any of several other devices in a building, is susceptible to interference. Thus, there may be limitations to the amount of data that can be transmitted at any given time and, even if data is transmitted, the target recipient may not receive it. LoRa-equipped devices also typically transmit data asynchronously, as the data is generated or based on configurations defined at the devices. For example, some devices can be configured to transmit data only at certain intervals to preserve power, such as when the device is a battery-operated sensor device.

Any of a variety of devices or equipment within a building can be configured to operate on a LoRaWAN for the building. Some devices in a building include built-in LoRaWAN communication modules that transmit data from the device to an external device, such as the gateway 108 or other building network nodes, or receive data from an external device. However, other devices may not include native LoRaWAN capabilities. Especially in an older building or a building in which equipment or sensors have different ages or are acquired from different sources, there may be many devices within a building that are not readily configured for wireless communication. It is expensive to replace equipment 104 or sensors 106 in a building with only devices that are preconfigured with LoRaWAN communication capabilities. Accordingly, smart adapters 110 can be used to provide LoRaWAN capabilities to devices that do not have native wireless communication capabilities. A smart adapter 110 according to implementations herein is a device that includes a wireless communication module, such as a LoRaWAN module. The smart adapter is configured to physically couple to equipment 104 or sensor 106 to communicate over a wired connection with the equipment 104 or sensor 106. Many equipment 104 devices or sensors 106 configured for operation within a building management system communicate by protocols such as Modbus or BACnet. In some implementations, the smart adapter 110 translates the equipment 104 or sensor 106 communications from the equipment or sensor's native protocol to signals that can be transmitted via the LoRaWAN module. Instead of or in addition to communicating with equipment 104 or sensors 106 via wired connections, some smart adapters 110 can be configured to communicate wirelessly with equipment 104 or sensor 106 using protocols such as Bluetooth, Wi-Fi, Zigbee, Thread or ultra-wideband (UWB).

A smart adapter 110 can include a processor and a memory and can be configured to implement one or more control protocols at the device to which the adapter is connected. Logic in the adapter can help ensure that devices continue to operate at least at a minimum level for safe or reliable operation of the device. For example, as described above, wireless networks sometimes suffer from unreliable links between components. Some systems operating in such wireless networks may therefore sometimes not receive updates from other components on the network, including updates that should cause the system to take an action (e.g., a sensor reading that should cause a system to change its output) or updates that should modify the processing performed by the system (e.g., instructions to modify a threshold against which a system should evaluate sensor readings). In building 102, for example, the absence of these updates can result in the control systems in the building 102 failing to maintain the building environment in a state that is safe and healthy for human occupants. The smart adapters 110 therefore are configured with logic that helps ensure redundancy and reliability in the building network.

In some implementations, smart adapters 110 can be used to monitor and/or control components on an existing BMS network. An adapter 110 can be coupled to a wired network within a building 102 such that the adapter 110 is able to receive communications over the wired network or over a wireless network (such as LoRaWAN) and to transmit communications across the wired network. Such a smart adapter can be configured to intercept and buffer commands received from another controller before injecting the commands onto the wired network.

The remote computing system 112 can include one or more servers, user devices, or other gateways 108 that transmit data to or receive data from the building network (e.g., via the LoRaWAN gateway). In some implementations, the remote computing system 112 handles storage and processing of building operation data, such as sensor readings or statuses of building equipment 104. The LoRaWAN gateway 108 within a building can send raw building operation data (such as each reading generated by a certain sensor) to the remote computing system 112 for analysis, or each node, an intermediate computing device, or the gateway 108 itself can pre-process the data prior to transmission to the remote computing system 112 (e.g., by computing an average value of a sensor's readings over a period of time). The system may receive control instructions from the remote computing system 112 via the gateways 108, sensors 106, and/or smart adapters 110, which may be transmitted to the building equipment 104 to change parameters.

### Distributed Building Management

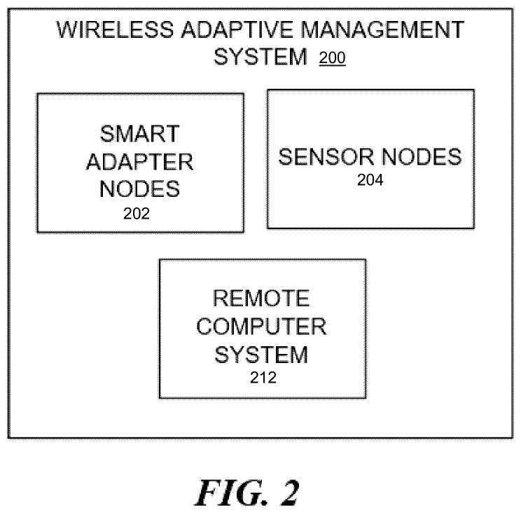

A wireless adaptive management system can be implemented in an environment with wireless-enabled devices, such as the building 102 depicted by way of example in FIG. 2. A block diagram of some implementations of the wireless adaptive management system 200 is illustrated in FIG. 2. The wireless adaptive management system 200 can enable flexible, distributed control of systems and devices in the environment. The system 200 can be modular, facilitating easy addition or subtraction of devices from the network. In at least some implementations, operation logic for the building can be distributed across nodes in the building, rather than operated through a central controller, to improve reliability of the network and safe operation of the building in case wireless data communications are not received, nodes in the building network fail, or the central controller is unplugged or damaged. Additionally, for buildings with multiple tenants that may desire to manage their spaces differently and retain privacy over their building data, the wireless adaptive management system 200 facilitates segmentation and encryption of tenant data so that each tenant's portion of the building can be individually managed.

In some implementations, control of an environment can be distributed to multiple levels in the wireless adaptive management system 200. Implementations of the wireless adaptive management system 200 are described herein with respect to managing an environment within a building, although similar systems can be implemented in other types of environments.

In some implementations, logic can reside at any node/device within the building network where it has access to the inputs and outputs applicable to the functions it performs. In at least some implementations, the control logic relevant to a building's operation is distributed across nodes in the building network. Implementing control logic at a node/device that is closer to the node/device or equipment system to be controlled by the logic, such as a LoRaWAN smart adapter, can, for example, improve efficiency of the building network and reduce the likelihood that interference interrupts or inhibits transmission of relevant data. On the other hand, redundancy can be built into the building network by implementing some of the same logic at multiple nodes within the building. However, in other implementations, some or all the control logic within a building can be implemented at one or more central controllers in the building. Such a central controller can be integrated into a LoRaWAN gateway, communicatively coupled to the gateway, or divided between multiple gateways or other computing devices within or external to the building network.

Control schemes for a building can include schemes to maintain a building environment at certain levels (e.g., maintaining health parameters that are comfortable for building occupation by humans, maintaining temperature parameters that are safe for food storage or preparation, or maintaining particulate concentration parameters that are appropriate for clean room operations), schemes to achieve certain targets (e.g., maintaining energy usage of the building below a specified threshold), or schedules that define different rules for building operation at different times. To implement these control schemes, control logic implemented at one or more devices in a building causes specified events in response to specified inputs. Such control logic can include, for example, instructions to: activate an air conditioning unit serving a room when temperature in the room exceeds a first threshold and turn off the unit when the temperature falls below a second threshold; activate a ventilation unit serving a room when carbon dioxide concentration in the room exceeds a threshold; turn on and turn off an air conditioning unit, a heating unit, or a ventilation unit according to proportional (P) control based on inputs and degree of threshold incursion, differential (D) control based on rates of change of temperature or ventilation, integral (I) control based on error between current and set-point temperatures or ventilation, or combinations of P, I, and D control; activate a ventilation unit and an air conditioning unit serving a room when occupancy of the room is predicted to be increasing; activate a ventilation unit instead of an air conditioning unit when temperature in a room exceeds a threshold during a time of day when energy prices are high; turn on, turn off, or change a parameter of a building equipment system at a specified time; or implement adaptive control to independently analyze other parameters on a building network to identify parameters that can be used to control a particular machine to better achieve a specified goal (e.g., achieving a target parameter within the machine, or modifying a system-wide parameter that can be influenced by the machine).

Some control logic can be received from the external remote computing system 212 and transmitted to various nodes in the building network to implement locally at the node. As control logic is updated at the remote computing system 212, for example in response to updated instructions received from a building manager, the remote computing system 212 can transmit the updated logic to the appropriate nodes in the network (e.g., through the gateway or a controller in the building).

Nodes within the building network can be further configured to manage data that is transmitted on the LoRaWAN network. In some implementations, logic within a node (e.g., a smart adapter node 202) causes the node to verify whether links to other nodes in the network are active. For example, if a sensor node 204 is configured to transmit a parameter measurement once per hour to a smart adapter node 202, the smart adapter node 202 can detect that the parameter's data is stale if the last received measurement from the sensor node 204 is more than one hour ago. Some nodes can also validate sensor node 204 measurements and eliminate or deprioritize measurements that are anomalous. Such validation can include, for example, comparing a sensor node's current output to a trend of recent measurements by the sensor node 204, comparing the sensor node's current measurement to average values of the measurement, or comparing the output of two nearby sensor nodes 204.

In some implementations, nodes in the network can be configured to implement reactive logic. For example, when all LoRaWAN links are operational within the building network, such reactive logic can cause equipment to change operating modes based on the status of other equipment or sensors on the network. Logic can also be updated, based on human or automated inputs, to modify equipment operating schedules or thresholds throughout the building. Implementing reactive logic at end nodes can be used to improve reliability and synchronization of the building's systems. The logic at end nodes can, for example, ensure that building systems continue to operate even if data is not received over the LoRaWAN network or if a device is offline.

In some implementations, some nodes implement failover logic that causes a system to operate in a prescribed manner when an expected signal has not been received over the LoRaWAN network. For example, a ventilation system can be controlled by a node (e.g., an adapter coupled to the ventilation system) that implements logic causing the system to turn off or reduce a degree of ventilation when a carbon dioxide measurement in a room is below a threshold, thereby reducing the ventilation system's power consumption. When carbon dioxide measurements are received from a sensor in the applicable room, the node controlling the ventilation system causes the system to turn on, turn off, or increase or reduce its operating parameters. However, if the ventilation system has not received a measurement of the carbon dioxide level in the room (e.g., due to interference on the LoRaWAN network), the node controlling the ventilation system can cause the system to operate independently of the carbon dioxide sensor reading. If a carbon dioxide measurement has not been received in a certain amount of time, for example, the node switches to failover logic that operates the ventilation system at a level that keeps the room at safe occupation levels regardless of the carbon dioxide in the room. Similar failover logic can cause a building system to operate on a certain schedule that defines specific times for the system to turn on and turn off, or to set an operating parameter such as a target temperature or ventilation rate.

In some implementations, other nodes can implement failover logic that operates in a prediction mode instead of a reactive mode when certain data needed for the reactive mode is unavailable. For example, a node can operate in a reactive mode that changes the operation parameter for a piece of equipment based on sensor measurements received from a sensor. When a new sensor measurement is unavailable, the node is configured to predict the value of the missing measurement based on recently received sensor measurements or based on historical values of the sensor measurements stored at the node. For example, if the temperature in a room typically increases throughout each morning as occupancy of the room increases but falls in the afternoon when occupancy decreases, a node controlling the air conditioning unit for the room can use these historical measurements to control the air conditioning unit, for example to increase operation of the air conditioning unit in the morning and decrease its operation in the afternoon. In some implementations, an artificial intelligence and/or machine learning algorithm may be used to predict the missing measurements. In some implementations, the artificial intelligence and/or machine learning algorithm may be trained using historical sensor measurements.

In some implementations, other failover logic can cause a node to change a source of data on which decisions are made. For example, if a node controlling a heating or air conditioning system for a room does not receive a temperature measurement for the room, the failover logic implemented by the node can cause the node to control the heating or air conditioning system based on a temperature received from an adjacent room under a presumption that the adjacent room will have a similar temperature to the room being controlled.

As discussed with respect to FIG. 1, the wireless adaptive management system 200 can further include a remote computing system 212 that can communicate with nodes in the building, optionally through a gateway. The remote computing system can store data received from the building, such as a history of sensor measurements captured in the building, history of building equipment status and operation levels, or history of any alerts or anomalies detected in the building or the components of the building network. The remote computing system can use the historical data to calculate derived parameters, such as overall energy consumption of a building or cost to operate a building. Additionally, the remote computing system can monitor trends in a building's parameters to detect anomalies that represent deviations from these trends, which may be indicative of equipment malfunctions, sensor failures, changes in usage patterns of a building, etc. Data collected by the remote computing system can be segmented by tenant or user to retain privacy of the data.

In some implementations, the remote computing system 212 can facilitate user interaction with the wireless adaptive management system 200. In some implementations, one or more user interfaces can be generated for display by the remote computing system 212 or by another computing device. For example, users can interact with the remote computing system 212 via web applications or mobile applications accessed by users' computers or mobile devices. These user interfaces can be used as a hub for building administrators or tenants to manage their data and building automation procedures. Through these user interfaces, the remote computing system 212 can provide dashboards or charts of real-time or historical data in a building to enable the user to assess the building's status. User interfaces can also receive input from the users to manage operations of a building or portions of a building, including inputs to modify the control logic implemented in a building, adjust thresholds, set schedules, or define goals for the building's operation. Such updates can be received from each tenant in a multi-tenant building, such as an office building, enabling each tenant to, for example, set their own schedules or to modify the logic or thresholds used to control operation of the portion of the building occupied by the tenant. The remote computing system 212 can further transmit alerts to building management or tenants, either via the user interfaces or by other communications channels such as SMS messages, emails, or push notifications.

The remote computing system 212 can further provide parameter measurements to the devices within a building that affect operation of the building's systems. For example, the remote computing system 212 can provide information about weather outside the building, which can be used to determine operating parameters to regulate the environment inside the building.

The gateway or another controller in the building network can further operate as a communication hub between nodes in the building network, passing information about sensor measurements or statuses of other systems in the building between the nodes. For example, if control logic at a controller dictates that a certain system should turn on when a sensor measurement indicates a certain parameter is above a threshold, the controller receives a notification of the sensor measurement and generates a command to the system to turn on in response to the receipt of the sensor measurement. However, in some implementations, nodes on the building network can communicate directly with one another, without passing communications through an intermediating controller.

### Smart Adapters

As described above, a network can include smart adapters that are configured to interface with systems in an environment to provide LoRaWAN communication capabilities to these systems. Examples of such systems may include, but are not limited to, equipment or sub-systems for HVAC, electrical, plumbing, lighting, occupancy, fire safety, IT devices, security, elevator/escalator, or sanitation, among others. Such systems can include a singular piece of equipment or sensor that is wired to a smart adapter, or multiple pieces of equipment or sensors together on a wired network to which the smart adapter is attached. In addition to connecting to a system and facilitating wireless communication to and from the attached system, the smart adapters according to at least some implementations can perform various tasks to control operation of the attached system. Control of attached systems by the smart adapters can help ensure that the systems operate efficiently and safely in a low-bandwidth, low-reliability communication environment. Furthermore, the smart adapters can improve efficiency of the network by performing at least some data processing and control functions locally, thereby not encumbering network bandwidth for these tasks.

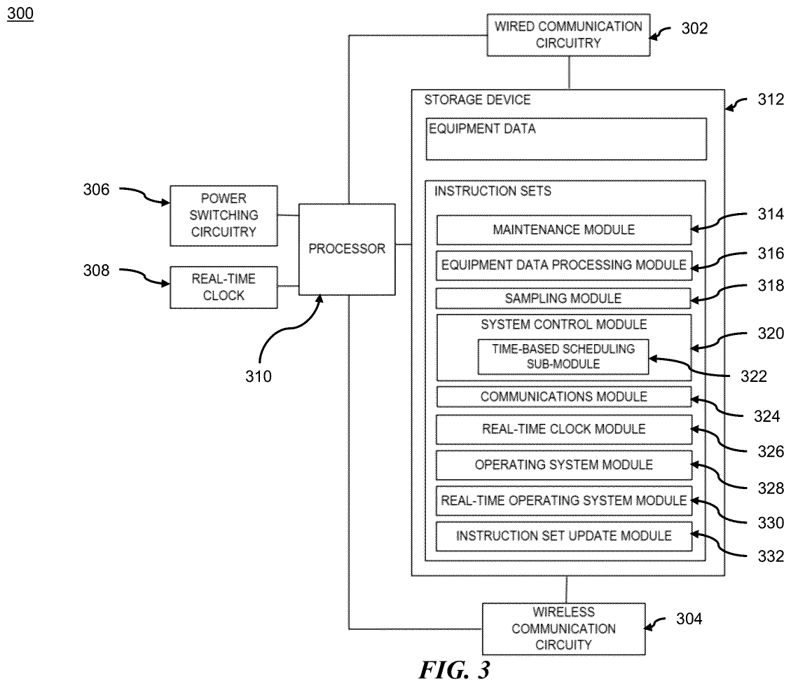

FIG. 3 is a block diagram illustrating example components of a smart adapter 300, according to some implementations herein. In some implementations, wired communication circuitry 302 is configured to interface with an environment system to send information to or receive information from the environment system. In some implementations wired communication circuitry 302 may comprise a physical interface (e.g., wire) that is connectable to an environment system. Signals transmitted over the physical interface can be signals that are compatible with a native signaling protocol used by the attached system. In some implementations, wired communication circuitry 302 can transmit signals to the attached system that include, for example, instructions to implement a command (e.g., to turn on or turn off the attached system, or to modify an operational parameter of the system). The wired communication circuitry 302 can also transmit instructions to the attached system to read or write a parameter or to increase or decrease a sample rate of a parameter. Signals received from the system can include these parameter measurements, status of the system's operational parameters, error codes generated within the system, or any other data generated by the system. In some implementations, wired communication circuitry 302 also includes power transmission circuit components, enabling the smart adapter to be powered by a power source of the attached system. In addition to being powered by the attached system, some implementations of the smart adapter 300 include a backup battery to ensure that the smart adapter can continue to operate if the attached system loses power, for example to maintain a clock or to notify other components in the building network of the power loss.

In some implementations, the interface between the smart adapter 300 and the attached system can include a wireless interface in addition to or instead of a physical interface. However, using a wired interface can improve reliability of data transfer between the smart adapter 300 and the attached system, to increase the speed of this data transfer, and to reduce latency and increase throughput between the devices.

In some implementations, wireless communication circuitry 304 is configured to transmit and receive data according to a wireless communication protocol, such as LoRaWAN. The smart adapter can transmit data to external systems, such as a LoRaWAN gateway, via the wireless communication circuitry. Similarly, external systems such as the remote computing system, the gateway, or other peer nodes in the building network can transmit data to the smart adapter, where it is received at the wireless communication circuitry 304. External systems may additionally or alternatively communicate with the smart adapter via wired communication circuitry 302.

In some implementations, power for the attached system to which a given smart adapter 300 is coupled is passed through the smart adapter 300. In some implementations, power switching circuitry 306 within the smart adapter 300 is configured to power cycle elements of the attached system based on the power for these elements being passed through the adapter. In some implementations, a real-time clock 308 maintains timing for components of the smart adapter 300 and/or attached system, at least in case a power loss clears or resets a system clock. In some implementations, the real-time clock 308 can be powered by an independent power source, such as a battery or an ultracapacitor.

In some implementations, a processor 310 of the smart adapter 300 can include a general purpose or special purpose processor coupled to the wired communication circuitry 302 and/or the wireless communication circuitry 304. In some implementations, the processor 310 is capable of executing instructions stored in the storage device 312 to cause the smart adapter 300 to perform various functions. For example, the smart adapter 300 can include programmable circuitry (e.g., one or more microprocessors), programmed with software and/or firmware, special purpose hardwired (i.e., non-programmable) circuitry, or a combination or such forms. Special-purpose circuitry can be in the form of, for example, one or more application-specific integrated circuits (ASICs), programmable logic devices (PLDs), field-programmable gate arrays (FPGAs), tensor processing units (TPUs), neural processing units (NPUs), vision processing units (VPUs), etc.

The storage device 312 can include any of a variety of volatile or non-volatile memory or data storage media, such as flash memory. The storage device 312 can store data received from the attached system or from external systems. For example, the storage device 312 can store sensor measurements received from a sensor associated with the attached system, sensor measurements received from an external sensor for control of the attached system, data regarding operational status of the attached system, data associated with alerts generated within the attached system, and/or data derived from one or more of these measurements or data types.

The storage device 312 can also store instructions or logic that are readable by the processor 310. FIG. 3 illustrates various example modules, where each module includes a set of instructions stored in the storage device that when executed by the processor 310 cause the processor 310 to perform one or more associated actions. As illustrated in FIG. 3, the storage device 312 can store instructions associated with a maintenance module 314, an equipment data processing module 316, a sampling module 318, a system control module 320, a communications module 324, a real-time clock module 326, an operating system module 328, a real-time operating system module 330, and an instruction set update module 332.

In some implementations, the maintenance module 314 performs setup and maintenance tasks of the smart adapter 300 itself or the system to which the adapter 300 is attached. These tasks can include automated operations that may be disruptive on a larger network, but that are feasible to perform on a local, dedicated device such as the smart adapter 300. For example, the maintenance module 314 can cause the smart adapter 300 to cycle through network configuration modes (e.g., baud, data bits, parity, stop bits, device address) to ascertain the configuration of the network's equipment automatically, instead of requiring humans to deduce or configure it. In another example, the maintenance module 314 can poll many registers on the attached system to attempt to determine the identity (e.g., make/model) of the system based on recognizable signatures in the registers. The system identity can be broadcast to other devices in the network or the overall system (e.g., a remote computing system) and/or used by the smart adapter 300 to configure control of the attached system.

Furthermore, some implementations of the maintenance module 314 perform diagnostic analyses of the attached system. The maintenance module 314 can obtain error codes or other diagnostic information from the attached system that may be helpful to identify the cause of any system errors or faults. Some implementations of the smart adapters 300 can include sensors that obtain fault diagnostic information, such as vibration sensors or sound sensors. The maintenance module 314 can further process the vibration or sound measurements received from such sensors to detect system faults, diagnose potential causes of faults, or transmit the diagnostic data to a remote computing system for analysis. If the attached system has crashed or failed in some way, the maintenance module 314 can cause the smart adapter 300 to take steps to correct the problem. For example, the maintenance module 314 can cause the smart adapter 300 to generate signals to power cycle the attached system or to reset software at the attached system to resolve crashes or errors.

In some implementations, the equipment data processing module 316 processes data received from the building system to which the smart adapter 300 is communicatively coupled. The data obtained or processed by the equipment data processing module 316 can be passed to the system control module 320 or output to another device or system for further processing or storage or to cause changes to parameters or operating modes.

In some implementations, the sampling module 318 implements various sampling rates that can be employed by other modules within the smart adapter 300. The sampling module 318 can select sampling rates for implementation on the attached system (e.g., by a processor or analog to digital converter within the attached system) or sampling rates for implementation by the smart adapter 300. Some example sampling rates that can be selected or implemented by the sampling module 318 include: a rate of sampling of any parameter of the attached system by way of a sampling rate configuration parameter within the attached system; a rate of sampling of the smart adapter's requesting of a parameter from an attached system (in non-polling “event-based” systems, for example, this could be a system configuration to announce a parameter at a certain rate); a rate of sampling that may be used by any smart adapter algorithm that is processing a collection of timestamped data; a rate of writing of any smart adapter data to a system parameter for control or other purposes; or a rate of communication of any parameter (or derived parameter) by the smart adapter 300 to any other system element, such as the remote computing system or any other node that may include control logic or otherwise make use of regularly provided parameter data from the smart adapter 300.

In some implementations, the system control module 320 implements logic to control operations of the system to which the adapter 300 is connected. Logic implemented by the system control module 320 can include logic to operate the attached system in a certain way, such as operating the attached system based on a predefined schedule or responsive to data generated by the attached system itself or data received from an external device over the wireless network (e.g., sensor readings). Some of the logic for controlling system operations can be implemented by a time-based scheduling sub-module 322. As described above, the smart adapter 300 can also maintain failover logic that causes the adapter 300 to operate the attached system in a specified manner when external inputs have not been received. The system control module 320 can accordingly evaluate whether to operate the attached system based on failover logic or based on non-failover or routine logic (e.g., by determining whether the sensor readings used for the routine logic have been received within an expected period). Based on the logic that is implemented, the system control module 320 generates control signals to the attached system.

The system control module 320 can include logic that is received from an external source, such as any node of the system illustrated in FIG. 1 including other nodes containing control logic, other smart adapters, central controllers, remote computing systems, or environment systems. Some of this externally received logic can be specified by a user who provides the logic via a remote computing system. Some of the logic executed by the system control module 320 may depend on data that is provided to the smart adapter 300 from an external source.

In some implementations, the system control module 320 can implement adaptive controls for the attached system. For example, the system control module 320 can analyze various parameters received over the network to identify parameters that are relevant for controlling the attached system to achieve a particular objective. In another example, the system control module identifies a parameter of the attached system that, when controlled according to a determined scheme, causes other systems within the network to achieve an objective.

Some implementations of the system control module 320 are further capable of deriving logic for controlling the attached system. As the attached system operates, the smart adapter 300 can collect and store data about the operation of the attached system and/or responses of other systems or parameters in the building to the operation of the attached system. For example, when the smart adapter 300 is connected to a cooling system of a building, the smart adapter 300 stores information about temperature measurements in the building (e.g., received from a temperature sensor) and operating parameters of the cooling system. Based on the stored data, the system control module 320 derives information about how to control the attached system. The system control module 320 may determine, for example, that the temperature in a room continues to rise for several minutes after the cooling system has turned on, and thus that the cooling system should turn on when the temperature in the room is below a desired set point temperature for the room. The system control module 320 can further use data received from external sources, such as a remote computing device or other nodes in the building network, to derive logic for controlling the attached system. For example, the system control module 320 can use outdoor weather data to predict how control inputs to the cooling system in a building will affect indoor temperature. Likewise, the system control module 320 can use data from other buildings to predict how the cooling system will affect the building in which it is located.

In some implementations, the communications module 324 processes data for transmission to external systems. As data is generated or measured by the attached system or the smart adapter 300 itself, the communications module 324 can package the data into a format that is suitable for transmission over a wireless network, such as a LoRaWAN network. The communications module 324 can also perform data pre-processing to select or modify the data that is transmitted over the wireless network. For example, instead of or in addition to transmitting raw data obtained from the attached system, the communications module 324 computes an average value, minimum value, or maximum of the raw data within a specified period of time. In some implementations, the communications module 324 determines when and how to generate data transmissions, considering reliability and bandwidth constraints of a LoRaWAN network.

In some implementations, the communications module 324 can implement policies to identify when to transmit data. Rather than transmitting any data that is received at a smart adapter 300 at the time the data is received, the communications module 324 can cause data to be stored or buffered (e.g., in the storage device) until certain criteria have been satisfied. Such criteria can consider features of the data, such as a priority assigned to the data and/or an age of the data. Other criteria can consider needs of other equipment on the network, an external system, or a human user, for example by causing the communications module 324 to only transmit data when it is requested by an external system or a human user.

In some implementations, the communications module 324 can adjust parameters of the data itself to improve the efficiency of transmitting the data over the LoRaWAN network. For example, when bandwidth is low or high levels of high-priority data are being generated, the communications module 324 can cause a sample rate or data precision of certain data items to decrease, such as by sending a signal to the attached system to reduce a data sampling rate at the attached system when the smart adapter detects that network bandwidth available for the associated data has fallen below a certain threshold. The communications module 324 can adjust a frequency at which it requests data from the attached device or can instruct the attached device to adjust a frequency at which the attached device reports data to the adapter or to other devices on the network. Alternatively, the communications module 324 can down-sample a stream of data incoming from an attached device to produce a lower-frequency data stream when network bandwidth is below the threshold. Similarly, the communications module 324 can reduce a precision of the data when network traffic is high, which may enable data to be transmitted in fewer bits.

In some implementations, the communications module 324 may modify the way data is packaged into LoRaWAN packets for transmission over the network to increase the amount of data that is transmitted in each packet. For example, as described above, a smart adapter 300 can be configured to communicate with an attached device via Modbus, which is a native communication protocol used by many systems. Modbus data packets have a 16-bit width. However, some items of data that are received from the attached device can be compressed into fewer than 16 bits. For example, a binary flag can be represented in a single bit, potentially with a few additional bits to transmit an identifier of the item to which the flag bit belongs. By reducing the number of bits to transmit at least some types of data, the communications module 324 can compress the data to pack data more efficiently into each LoRaWAN frame.

In some implementations, the operating system module 326 facilitates sharing of resources, such as processing or memory resources, across multiple processes or threads of the smart adapter 300. The real-time operating system module 328 facilitates the execution of instructions according to precise time intervals or within specific latencies. In some implementations, the instruction set update module 330 manages reliable replacement of any instruction sets used by the smart adapter 300 or attached system. The instruction set update module 332 can receive updated instruction sets over wired or wireless communication. If a failure is detected, the instruction system update module 332 can facilitate failover to prior instruction sets until modified instructions have been received.

Smart adapters can have additional, fewer, or different components than illustrated in FIG. 3. Some smart adapters do not have all the functionality described with respect to FIG. 3. Within a network, smart adapters with varying amounts of functionality can be used.

### Large Language Model-based Building Management

According to some implementations, a system for management of an environment can leverage multimodal generative artificial intelligence (AI) and/or machine learning (ML) models, such as a large language model (LLM), to facilitate management of an environment. Traditional environmental systems often rely on pre-set schedules and manual adjustments, which can lead to inefficiencies and suboptimal performance. By integrating AI and ML, these systems can be transformed into intelligent, adaptive networks that continuously learn and adjust to changing conditions, enhancing efficiency, comfort, and sustainability. A network of nodes (e.g., sensors) distributed throughout an environment may be to collect real-time data on various environmental parameters, such as temperature, humidity, occupancy, and air quality. This data may be transmitted to an AI/ML model(s), which processes the information using advanced algorithms to identify patterns and predict future conditions. The AI/ML model(s) can make informed decisions to adjust the operation of environmental systems. Moreover, an AI/ML-driven system can integrate with multiple environmental systems, such as lighting, HVAC, and security, to provide complete solution to building automation. By leveraging the interconnected nature of modern smart buildings, the AI/ML module can coordinate multiple systems to achieve optimal performance and energy savings.

As used herein, the term “model” can include any one or a combination of computer-based AI and/or ML models of any type and of any level of complexity, such as any type of sequential, functional, or concurrent model. Models can further include various types of computational models, such as, for example, artificial neural networks (“NN”), language models (e.g., LLMs), AI models, ML models, multimodal models (e.g., models or combinations of models that can accept inputs of multiple modalities, such as images and text), and/or the like. In various implementations, the one or more models of the present disclosure may be locally hosted, cloud managed, accessed via one or more Application Programming Interfaces (“APIs”), and/or any combination of the foregoing and/or the like. Additionally, in various implementations, the one or more models of the present disclosure may be implemented in or by electronic hardware such as computer processors.

Examples of models, language models, and/or LLMs that may be used or altered in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), BigScience Large Open-science Open-access Multilingual Language Model (BLOOM), T5 (Text-to-Text Transfer Transformer), RoBERTa (Robustly Optimized BERT Pretraining Approach), XLNet, ALBERT (A Lite BERT), DistilBERT, ERNIE (Enhanced Representation through Knowledge Integration), Turing-NLG, and Mistral and future versions of other such open and commercial foundation models.

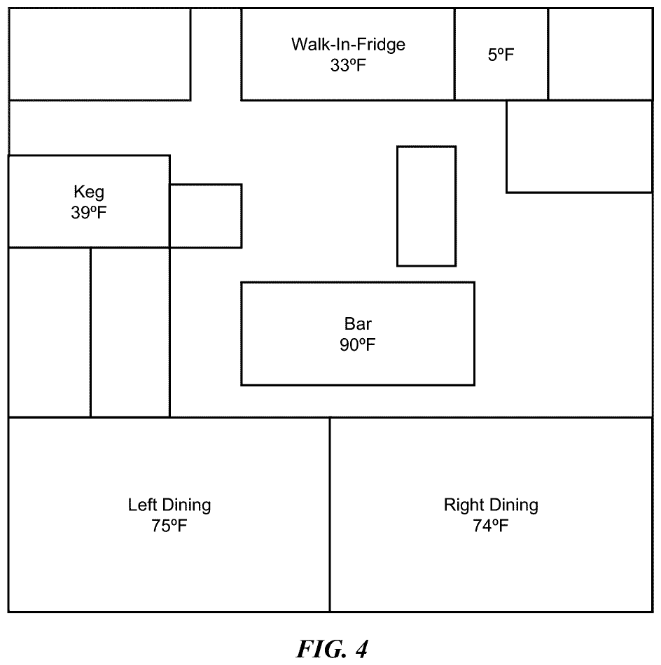

Multimodal generative AI/ML models, including LLMs, can process images, text, tabular data, or any other type of data that may relate to features of an environment or status of systems or sub-environments within an environment. In the example of a building, visual diagrams, such as a floorplan diagram can be input to an LLM for analysis. For example, if a floorplan diagram such as the example floorplan of FIG. 4 is provided to an LLM according to the implementations herein, an output may be generated, such as:

“Based on the screenshot provided, which appears to be a floorplan of a building with temperature readings in various zones, I can make the following observations:

### 1. Comfort:

The areas labeled as “Left Dining” and “Right Dining” have temperatures of 75° F. and 74° F., respectively. This is typically considered a comfortable range for most people in a dining setting.
The bar area is at 90° F., which is quite warm and may be uncomfortable for patrons and staff. This could indicate an issue with the HVAC system in that zone or high heat-generating equipment.

### 2. Refrigeration

The area labeled “Walk-in Fridge” is at 33° F., which is just above freezing and is a typical temperature for a commercial walk-in refrigerator.
The space with a temperature of 5° F. could be a freezer, which is within the appropriate range for frozen goods.
The “Keg” area is at 39° F., which is a bit on the warmer side for beer storage but still within acceptable limits. However, closer to 34° F. or 35° F. might be more optimal.
   So based on the given temperatures:
There might be a comfort issue in the bar area due to the elevated temperature.
The refrigeration zones seem to be functioning correctly, but the keg storage could be slightly warmer than optimal.
   However, these observations are based solely on the provided temperatures and there could be other factors or reasons for these readings. It would be essential to assess the equipment and systems in place and possible consult with building or refrigeration experts to get a more accurate understanding.”

As shown above, in some implementations, the output from the model can include at least the following data: an identification that the input is a floor plan with loosely bounded regions; and identification of region names based on text names placed on/near the regions; an identification that temperature numbers placed near/in certain regions represent the temperature in the region; an identification of the nature of the region based on the names (e.g., dining, bar, etc.); and suggestions based on observations of the data.

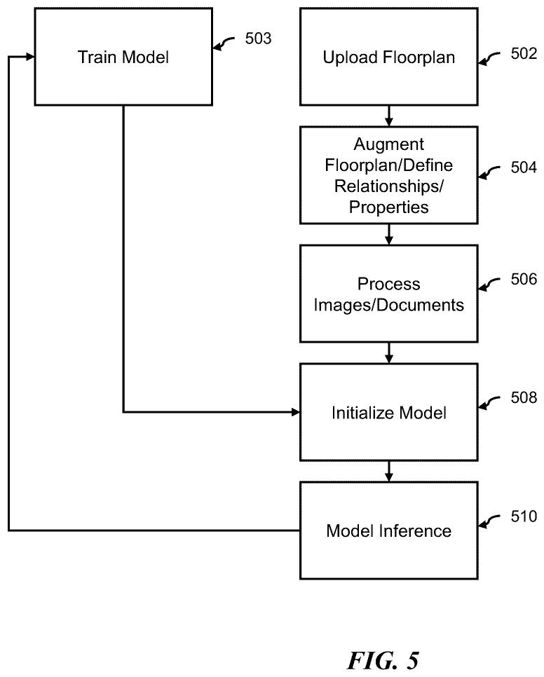

In some implementations, the system can be configured to utilize a model to answer questions about a building according to the process illustrated in FIG. 5. In some implementations, at 502, a user may upload a pre-existing floorplan digital file (e.g., hand-drawn or CAD). The model may be trained at 503 on a diverse dataset of floorplans, architectural drawings, and building layouts to recognize and interpret various elements commonly found in these documents. When a user uploads a floorplan, the system may first use image processing techniques to enhance the quality and clarity of the image. The model may then analyze the floorplan content, identifying and categorizing different elements such as walls, doors, windows, staircases, and room labels, among others. The model may recognize standard architectural symbols and notations, interpreting their meanings within the context of the overall layout. The model may be capable of understanding different scales and measurement units used in the floorplan, allowing it to accurately assess room sizes and building dimensions. For floorplans with textual annotations, the model may employ optical character recognition (OCR) in conjunction with its natural language processing capabilities to interpret room labels, area designations, and any additional notes or specifications provided. The system may use this comprehensive understanding of the floorplan content to generate a detailed digital representation of the space, including room types, spatial relationships, and potential traffic flow patterns. This digital model may then be used to suggest optimal placements for building management system components, such as sensors, thermostats, or other monitoring devices. The model may also analyze the floorplan content to identify potential issues or opportunities for improvement in the building's layout or functionality, such as suggesting more efficient space utilization or highlighting areas that may require special attention for energy management. As the system processes more floorplans over time, it may continuously refine its ability to interpret and analyze various styles and formats of architectural drawings, adapting to different conventions and notations used across different regions or industries.

In some implementations, the content of the floorplan provided to the model may only contain bounding regions and names (e.g., architectural plans). In some implementations, the floorplans may include supplementary information (e.g., mechanical/electrical/plumbing plans). In some implementations, at 504, a user interface may be provided, such that the user is given affordances to augment the image by placing additional environment elements (e.g., sensors, mechanical/electrical/plumbing equipment, etc.) in the form of user-specified names or shapes. In some implementations, these elements allow the model to better understand the spatial relationships between the pre-existing floorplan/elements and the user-added elements. In some implementations, the user, via the user interface, is given further mechanisms to place other visual identifiers such as zones (e.g., regions in the building that share environmental controls, often with known relationships to HVAC equipment that affects said zones). In some implementations, the user is equipped via the user interface with mechanisms to add additional text/shape annotations/labels to the floorplan image, such that the model can better understand the floorplan (e.g., a more detailed name for a room such as “Bob's Office” instead of the original generic architectural plan name “Office 101”). Furthermore, the user interface may enable the user to indicate (graphically or with text) relationships between system elements. For example, at least the following relationships may be defined between system elements: parent-child relationships, sibling relationships, source/destination, and/or input/output relationships.

The user interface may enable the user to indicate relationships between system elements through various interactive methods. Graphically, users may be able to draw lines or arrows between elements to establish connections, or use drag-and-drop functionality to nest elements within others, creating parent-child hierarchies. The interface may also provide options for color-coding or applying specific visual markers to denote different types of relationships. For text-based indications, users may be able to input commands or use a structured format to define relationships. This could include using specific keywords or syntax to denote relationship types or filling out forms with dropdown menus to select relationship categories.

Parent-child relationships may be used to represent hierarchical structures within the building management system. For example, a central HVAC unit could be designated as a parent to multiple zone controllers or individual room thermostats. This hierarchy may help in organizing and managing complex systems with multiple levels of control. Sibling relationships may be utilized to group elements that operate on the same level or have similar functions. For instance, all sensors on a particular floor could be designated as siblings, facilitating collective management and data analysis. Source/destination relationships may be particularly useful for mapping data flow or control signals within the system. Users may indicate which elements generate data (sources) and which elements receive or act upon that data (destinations). In some implementations, input/output relationships may allow users to specify how different elements interact in terms of data or control signals. For example, a temperature sensor could be designated as an input for an HVAC controller, which in turn may have outputs to various heating or cooling elements.

The system may use these user-defined relationships to generate more accurate system diagrams, improve data visualization, and enhance the overall management and control of the building systems. The model may analyze these relationships to provide more context-aware insights and recommendations, considering the interconnected nature of the various building management components.

Furthermore, the user interface may provide a comprehensive set of affordances for users to input and manage detailed information about various equipment within the building management system. These affordances may be presented as form fields, dropdown menus, or interactive elements within the interface. For example, a name field may allow users to input a human-readable identifier for the equipment, which could be used in reports, alerts, or verbal communications. Category selection may help organize equipment into broad functional groups, facilitating easier management and reporting. In some implementations, categorization may also enable the system to apply relevant rules or analysis methods specific to each category. A “type” field may further refine the equipment classification, allowing for more specific management strategies and performance comparisons between similar types of equipment across different buildings or locations.

In some implementations, the user interface may comprise a freeform text input for description that enables users to add any additional context or notes about the equipment that do not fit into other predefined fields. For example, freeform text input may include information about the equipment's location, specific operational characteristics, or any unique features. Other fields for manufacturer, model, and serial number may be included for maintenance purposes, warranty tracking, and sourcing replacement parts. In some implementations, the model and/or system may access manufacturer-specific data or recommendations for optimal operation. Additionally in some implementations, an installation date field may help track the age of the equipment, which can be used by the model to predict maintenance needs, estimating remaining lifespan, and planning for replacements. Similarly, a field for past service dates with descriptions may create a maintenance history for each piece of equipment. This historical data may be analyzed to identify patterns, predict future maintenance needs, or assess the effectiveness of different service procedures. Future service dates with descriptions may serve as a planning tool for proactive maintenance. The system may use this information to generate reminders, schedule technicians, or order necessary parts in advance.

In some implementations, the model may analyze the data entered through these affordances to provide insights such as predicting equipment failures, optimizing maintenance schedules, or suggesting energy-saving operational adjustments based on the specific characteristics of each piece of equipment. The system may also use this detailed equipment information to generate more accurate and informative visualizations, such as system diagrams or performance dashboards tailored to the specific equipment installed in each building.

Alternatively, in some implementations, the model may be provided with image(s) of the equipment or its markings/nameplate, from which the model may infer properties for the user. In some implementations, the user is given affordances via the user interface to upload documents (e.g., vendor spec sheets and manuals) which describe the nature and operations of the equipment in detail. The model may be configured to correlate these documents to the system elements, or the user may be needed to establish or correct the relationships.

In some implementations, the system may include equipment that captures past/present states of any system elements (e.g., Internet connected sensors or machines with internal states that are readable). In some implementations, the system may provide to the model the state along with an identifier of the system element that is relevant to the state.

Current/recent state values may be continuously updated in real-time or near real-time and provided to the model. These values may include temperature readings, energy consumption, occupancy levels, or equipment operational status, among other. Past state values as a full time series may allow the model to access historical data for any monitored parameter. This comprehensive dataset may be used by the model for identifying trends, analyzing system performance over time, or investigating past incidents. Furthermore, using the full time series of past state values, the model may perform detailed pattern recognition and predictive analytics. For example, the model may identify cyclical patterns in building usage or equipment performance, forecasting future states or maintenance needs based on historical trends. In some implementations, aggregated past values (e.g., maximum, minimum, average, sum, etc.) may allow the model to perform benchmarking analyses, comparing performance across different time periods or against similar buildings in a database. In some implementations, the model may use threshold levels to generate alerts and recommendations. For example, the model may be configured to analyze how often thresholds are approached or exceeded, suggesting adjustments to equipment settings or operational procedures to optimize performance and avoid issues.

In some implementations, building property information may be used to contextualize other data available to the model and may be provided via the user interface. The model may adjust its analysis and recommendations based on the specific location, usage type, construction materials, and building characteristics. For example, the model may provide different energy-saving strategies for a brick restaurant in a cold climate versus a wood-framed office in a warm climate. The model may also use this information to generate more accurate and relevant visualizations. It could create custom dashboards that highlight the most pertinent information for each specific building type or generate floor plans with heat maps showing how different construction materials and insulation types affect temperature distribution. Furthermore, the model may use this comprehensive dataset to simulate various scenarios. For instance, the model could predict how changes in occupancy, weather, or equipment settings might affect energy consumption and comfort levels, considering the building's specific characteristics and historical performance.

In some implementations, the user interface may provide mechanisms for users to upload and manage photos of the environment (e.g., building), both exterior and interior. For exterior photos, users may upload multiple images showing different angles or aspects of the building. The model may analyze these photos to infer information about the building's architecture, materials, and overall condition. The model may also identify features such as the type of roof, presence of solar panels, window configurations, or external HVAC units. The model may use this visual information to supplement or verify the manually entered building characteristics.

For interior photos, the interface may allow users to associate uploaded images with specific areas or elements on the building drawings. The model may analyze these interior photos to recognize equipment, assess room layouts, or identify potential issues such as signs of water damage or poor insulation. By establishing relationships between photos and named building elements, the system can create a more comprehensive and visually rich representation of the building's interior.

As described above, a freeform text input mechanism may also allow users to provide additional context, observations, or details about the building, system elements, or relationships that may not be captured by structured data fields or photos alone. For example, users may include information about recent renovations, known issues with certain equipment, or specific operational procedures. The interface may provide this option at various points in the process, such as when uploading photos, describing equipment, or defining relationships between system elements.

In some implementations, the model may process this freeform text input to extract relevant information and integrate the text with other data sources. In some implementations, the model may identify key terms or concepts related to building management and use this information to enhance the model's understanding of the building's unique characteristics or operational nuances. The model may also use this text input to generate more accurate and context-aware responses to user queries or to provide more tailored recommendations. By combining visual analysis of photos, structured data about building elements and relationships, and insights from freeform text input, the model may develop a more comprehensive and nuanced understanding of the building. This multi-modal approach may enable the system to provide more accurate simulations, better-informed recommendations, and more relevant insights for optimizing building performance and management.

In some implementations, at 506, the system may employ sophisticated image processing techniques to create a compute-efficient representation of the user-supplied annotations for the model to process. This combined image may serve as a compact yet information-rich input for the model. In some implementations, the original floorplan image may be preprocessed to enhance relevant features while reducing noise or unnecessary details. In some implementations, preprocessing involves techniques such as edge detection, contrast adjustment, or resolution optimization such that key structural elements are clearly visible without overwhelming the model with extraneous information. In some implementations, the system may also overlay the physical locations of user-augmented system elements onto this processed floorplan image. Each element may be represented by a marker or icon positioned accurately within the floorplan. To maximize efficiency, these markers may be designed to be as small as possible while still being distinguishable by the model. In some implementations, unique identifiers for each system element may be incorporated into the image using a compact encoding scheme. In some implementations, a combination of colors, shapes, or patterns are used to represent different types of identifiers. In some implementations, the system may employ techniques such as QR code-inspired designs or custom symbolic languages.

In cases where the shape of user-augmented system elements is deemed useful for model inference, the system may include simplified representations of these shapes in the combined image. These shapes may be stylized or abstracted versions of the actual elements, designed to convey key characteristics (such as size, orientation, or general form) without requiring excessive detail or image space. In some implementations, the combined image may also incorporate additional layers of information through variations in color, texture, or pattern. This could allow for the encoding of multiple attributes for each system element (such as type, status, or relationships to other elements) within a single, visual representation.

In some implementations, the system may employ dynamic image generation techniques, adjusting the level of detail and information density based on the specific requirements of the analysis task at hand. In some implementations, multiple versions of the combined image may be generated, each optimized for different aspects of model processing. By distilling the user-supplied annotations into one or more highly optimized visual formats, the system may enable the model to process and analyze complex environment information more efficiently. Thus, the system enables faster processing times, reduced computational resource requirements, and more accurate inferences by presenting the most relevant information in a format specifically designed for model consumption.

In some implementations, the system may allow users to upload photos of specific system elements, associating each photo with a unique identifier that correlates it to one or more system elements. In some implementations, when uploading photos, the user interface may prompt users to select the relevant system element(s) from a list or interactive diagram. Alternatively, the system may employ computer vision techniques to automatically recognize equipment in the photos and suggest potential matches with known system elements. In some implementations, the system may generate a unique identifier for each photo, including a combination of the system element's ID and additional metadata such as timestamp or sequence number. This identifier may be embedded within the image file's metadata or stored in a separate database linked to the image.

In some implementations, the model may be provided with these photos along with their associated identifiers as part of its input data. This visual data may allow the model to gain a more comprehensive understanding of the system elements, identifying characteristics or conditions that may not be captured in text-based descriptions alone. In some implementations, the model may analyze these photos to extract relevant features such as equipment condition, installation quality, or environmental factors that could affect performance. This visual analysis may be integrated with other data sources to provide more accurate assessments and recommendations.

An additional model process may be employed to automatically establish relationships between system elements without requiring direct user input. For example, the model may analyze the combined floorplan image, system element locations, and associated photos to infer spatial relationships between elements. For example, the model may identify which elements are in proximity or which are likely to be part of the same subsystem based on their positions and types. In some implementations, the model may examine the characteristics and functions of different system elements to deduce logical connections. For instance, the model may infer infer that a thermostat is connected to nearby HVAC equipment, or that certain sensors are associated with specific control units.

By analyzing historical data patterns, the model may identify correlations in the behavior or performance of different system elements, suggesting potential relationships or dependencies. Additionally, the model may be trained using typical building system architectures to allow the model to make educated guesses about how elements are likely to be interconnected in standard configurations. As the model processes more buildings and receives feedback on its inferences, it may continuously refine its ability to accurately establish relationships between elements without user input. Automated relationship establishment may significantly reduce the manual effort required from users and reveal connections that might not be immediately apparent. In some implementations, the system may present these inferred relationships to users for verification or adjustment, using them as a starting point for more detailed system mapping.

In some implementations, once the provided images and documents have been processed and prepared for input to the model, the system may initialize the model with both static and dynamic information at 508. For static information initialization, the system may compile all unchanging data about the environment and its systems into a structured format optimized for model consumption. This static information may include building characteristics, equipment specifications, system layouts, and historical documents. As noted above, a preprocessing step 506 may be implemented to convert this static information into a standardized, compact representation that can be efficiently loaded into the model's context or memory. In some implementations, the system may generate a comprehensive “building profile” that encapsulates all static information, which can be used to quickly initialize or reset the model's knowledge base about the specific building.

In some implementations, if users make changes to any static information, the system may automatically detect these updates and trigger a reinitialization process for the model. In some implementations, the system may selectively update only the affected portions of the model's knowledge base, rather than performing a full reinitialization.

For dynamic information updates, the system may implement a real-time data pipeline that continuously collects and processes information from various sensors, equipment state monitors, and other dynamic data sources, such as through smart adapters, throughout the environment. In some implementations, a prioritization mechanism may be employed to determine the frequency and urgency of updates for different types of dynamic information. Critical data (e.g., safety-related sensors) may be updated immediately, while less crucial information may be batched and updated periodically. Furthermore, in some implementations, the system may use intelligent data compression and summarization techniques to reduce the volume of dynamic information that needs to be processed by the model. In some implementations an event-driven architecture may be implemented, where significant changes or anomalies in dynamic data trigger immediate updates to the model, allowing for rapid response to changing conditions.

In addition, in some implementations, the system may employ a sliding window approach for temporal data, maintaining a recent history of dynamic information in the model's active memory while archiving older data for long-term analysis. To optimize performance and resource utilization, the system may implement a caching mechanism that stores frequently accessed or computationally expensive information derived from the model's analysis. In some implementations, the system may use predictive loading techniques to anticipate which information the model is likely to need based on current trends or scheduled operations, preemptively updating relevant data.

In some implementations, after initializing the model, the system may perform the various inference operations at 510.

In some implementations, a user may prompt the model, or the system may automatically prompt the model at regular intervals to analyze current data and identify potential issues in the environment. In some implementations, this analysis may cover various aspects such as equipment performance, energy efficiency, comfort levels, and maintenance needs. If the model detects any problems, it may generate a notification with, for example, detailed description of the issue, its potential causes, possible solutions, and possible impacts.

In some implementations, the system may implement a severity classification mechanism, categorizing identified problems based on urgency and potential consequences. This classification may determine the notification method and priority. Notifications may be tailored to the user's preferences and the problem's severity. For critical issues, immediate SMS alerts may be sent, while less urgent matters may be communicated via email or displayed on a web dashboard. The notification may include a concise summary of the problem along with a link to access the full model-generated description.

In some implementations, the system may regularly task the model with generating comprehensive performance summaries for the building and its various systems. These summaries may cover key areas such as comfort metrics, air quality indicators, energy consumption patterns, occupancy trends, and equipment efficiency, among others. In some implementations, the model may analyze historical data alongside current readings to identify trends, improvements, or areas of concern. The model may also compare performance against predefined benchmarks or goals. Summaries may be customized based on user roles or preferences. For example, facility managers might receive detailed technical summaries, while executives may get high-level overviews focusing on key performance indicators. The system may present these summaries through various interfaces, such as interactive web dashboards, scheduled email reports, or periodic SMS updates, depending on user preferences and the nature of the information.

When more concise communication is needed, the system may employ a two-stage model process. The first stage generates a comprehensive analysis or summary, which is then fed into a second model operation specifically trained in content summarization. This secondary model may be optimized for different output formats, such as bullet points for web displays, short paragraphs for emails, or character-limited summaries for SMS messages. In some implementations, a single model may be used for both comprehensive analysis and summarization.

In some implementations, the model may be configured to perform analysis and management of complex environments such as multi-building complexes. In some implementations, for each building, the model may generate a standardized performance summary, including key metrics and notable characteristics. In some implementations, the system may aggregate individual building summaries along with relevant system-calculated data into a structured format suitable for comparative analysis. In some implementations, a separate LLM operation may then be performed on this aggregated dataset, allowing for complex queries and analysis across the entire portfolio of buildings. In some implementations, users or the system may pose questions to the model(s) about the collection of buildings, such as identifying top performers in energy efficiency, comparing maintenance needs across different building types, or analyzing the impact of specific management strategies across multiple properties. In some implementations, the LLM may generate multi-modal visualizations or reports that highlight trends, outliers, or correlations across the building portfolio.

### Recommendations for Monitoring and Control of Building Networks

The network of sensors within a building and communication links to external systems provide rich data sources that can be mined and analyzed to improve monitoring and/or control of a building. According to some implementations, a computing system, such as the remote computing system, may analyze operations data received from a particular building or from multiple buildings to develop monitoring or control recommendations. Examples of such recommendations are described below. These recommendations are described herein as being generated by the remote computing system, but in other implementations can be generated by a device within a building network (e.g., the LoRaWAN gateway or one or more controllers within the building).

In addition to the applications noted above, a remote computing system or central controller of the system can use any of a variety of models, statistics-based models, or other data mining or pattern identification techniques to generate recommendations for environment monitoring and control. As noted above, such models can include neural networks or random forest models that are trained according to the implementations described above, and/or using historical data obtained from buildings, such as a history of sensor readings in the building, a history of building equipment operation parameters, a history of weather measurements at the building's location, or other data that may relate to or affect a building's performance under various conditions. In some implementations, the remote computing system can instead mine such datasets using statistical techniques to identify patterns or causal relationships between parameters that can be used to derive recommendations for operating a building to achieve specified goals.

Recommendations generated by the remote computing system can be output to a user in any of a variety of forms. For example, some recommendations can be provided in a regular building operations summary produced by the remote computing system, generated on a periodic basis (e.g., once per week) to summarize the performance of a building over the previous period. Other recommendations can be output via a dashboard that displays real-time or historical building management data. Still others can be added to an electronic communication that is transmitted to a designated user or device on-demand or at a periodic interval. In some implementations, the remote computing system uses a model to generate natural language recommendations, feeding values or identifiers of objects in structured or unstructured data to the large language models with instructions to produce a natural language output to communicate the recommendation to a user. In some implementations, the remote computing system can cause some recommendations to be automatically implemented in a building, such as by instructing a gateway to perform a specific task (e.g., to modify an alert threshold or to increase a temperature set point for a given zone in a building).

In some implementations, one type of example recommendation that can be generated by the remote computing system is a recommendation to add assets to a set of managed building assets. Many buildings have equipment, such as HVAC equipment, on top of or adjacent to the building. The remote computing system can access a satellite photo of a target building and process the satellite photo to recognize such equipment. If the recognized equipment is not already part of the set of assets being managed through the building network, the remote computing system can recommend that the equipment be added to this set.

The remote computing system can similarly process floorplans of a building to make recommendations for building monitoring or control. A user, such as a building manager, can upload floorplans for analysis by the remote computing system. Based on the floorplans (and, optionally, other information), the remote computing system identifies zones of control in the building, determines room labels, or recommends sensor types or layouts. For example, the remote computing system can analyze a floorplan to determine contiguous areas within the building (e.g., those that are not separated by walls) and to thereby identify zones for building management based on these contiguous areas. In another example, the remote computing system processes room labels on a floorplan to determine the types of rooms that are present within the building. Instead of or in addition to processing explicit labels on the floorplan, the remote computing system can predict the purpose of rooms in the building based on features such as the type of building (e.g., office building, restaurant, or school), the location of the room, the size of the room, shape of the room, any objects within the room that are labeled or depicted, or other features that may be discernible from the floorplan.

The remote computing system can generate recommendations for types and placements of sensors within a building that will improve efficient monitoring and control of the building. The recommendations for types and placements of sensors can be based on zones within the building and/or the nature of each room in the building, which can be automatically determined by the remote computing system as described above or can be provided by the user. In one example, the remote computing system determines that a room within the building is not being monitored because no sensors are currently placed in the room or its contiguous zones. Thus, the remote computing system may recommend that at least one sensor be added to the room, depending on the type of room or its location. For a room that is occupied by people during a large portion of a day, such as a dining room in a restaurant, a classroom in a school, or an open working area in an office, the remote computing system may recommend both a temperature sensor and a carbon dioxide sensor to ensure that temperature and ventilation remain at levels that are comfortable for continuous occupation, for example. For a room that is likely to only be occupied during portions of a day, such as a conference room in an office or a private dining room in a restaurant, the remote computing system may recommend an occupancy sensor that can be used to detect when the room is occupied. For a room that has a specialized purpose, several types or quantities of sensors may be recommended than for other types of rooms in a building. For example, for a clean room or a laboratory, the remote computing system may recommend an air quality sensor.

The remote computing system can also generate recommendations to move sensors in a building. For example, the remote computing system can determine that two sensors are too close together based on a floorplan that shows the two sensors being located within the same room or within a threshold distance of each other. In response to this determination, the remote computing system determines that one sensor can be moved to another location. Alternatively, the remote computing system may recommend that a first sensor be moved if there is a second sensor that measures the same parameter as the first sensor and that produces a measurement that is highly correlated with the measurements produced by the first sensor.

In some implementations, the remote computing system recommends replacing a sensor in the building with a different sensor. For example, if a temperature sensor in a walk-in refrigerator is not rated for the typical temperature range of the refrigerator, the remote computing system can recommend that the sensor be replaced by a different temperature sensor that is rated for the appropriate temperature range.

Recommendations for sensor types or locations in a target building can be based on other buildings that are being monitored by similar building monitoring and control systems and that communicate their data to the remote computing system For example, if a particular sensor type is usually used in rooms with a particular label, the remote computing system can recommend this sensor type for use in similarly-labeled rooms in the target building. The remote computing system can further use data from other buildings to determine types of sensors that are better for certain locations than others. For example, if a particular type of sensor installed in several buildings produces a large quantity of anomalous measurements, the remote computing system can recommend that the sensor type be replaced with another sensor type that does not produce as many anomalous readings.

As described above, data from external sources can be used to supplement building-generated data to improve the monitoring or control of the buildings connected to the remote computing system. Another recommendation that can be generated by the remote computing system is a recommendation to add an external data source to the set of data sources used to manage a building. In some implementations, the remote computing system identifies a data source for a parameter that is not currently used for management of a target building but that is highly correlated to or at least a partial cause of an effect in a building. For example, if a target building is not currently using weather data in its building management scheme but the amount of power used by the building on a given day is highly correlated to the exterior temperature on that day, the remote computing system can recommend that weather data be added as a data source used for the target building's management. Recommendations for external data sources can also be made based on the data sources used to manage other buildings.

The remote computing system can further generate recommendations for types, frequency, and/or content of communications related to monitoring performance of a building. These recommendations can include recommendations related to building alerts. Alerts can be generated when one or more metrics in a building satisfy an alert criterion. For example, an alert can be generated when a specified parameter exceeds or falls below a specified threshold, when a specified parameter remains above or below a specified threshold for a specified amount of time, when a value of a specified parameter has not been received in a specified amount of time, or when a specified number of events have occurred within a specified window. An example recommendation generated by the remote computing system is a recommendation to increase or decrease a particular alert threshold, based on data such as a distribution of historical values of the corresponding parameter, a magnitude of deviation of a parameter's values, the effect of the corresponding parameter on other parameters or functions in the building, or preset guidelines for acceptable parameter values in the building. For example, the remote computing system can recommend setting an alert threshold to a value that is approximately two standard deviations above the mean value of the corresponding parameter. The remote computing system can instead recommend changes to the frequency at which alerts are generated or reported to a user.

Other recommendations related to types, frequency, or content of communications can relate to summary reports generated by the remote computing system. Summary reports can be generated on demand or at regular periodic intervals. The remote computing system can recommend certain parameters, metrics, or alerts to include in these reports or certain ways that parameters, metrics, or alerts should be aggregated or presented. Parameters, metrics, or alerts can be recommended based on the content of summary reports generated for other buildings, especially other buildings that are similar to the target building. Alternatively, the remote computing system can identify parameters, metrics, or alerts that are correlated to a goal for a building, such as parameters that relate to a building manager's goal of improving energy efficiency of the building. Furthermore, the remote computing system can recommend an amount of time that should be aggregated for a summary report or the relevant comparison point for a given metric or parameter. Such recommendations can be based on a frequency of change that is measured in each parameter or metric. For example, if a metric varies significantly over the course of a week (e.g., due to different building use patterns on different days of the week) but its average value in one week is approximately equivalent to its average value across the next week, the remote computing system can recommend that the summary report include a weekly comparison of the metric rather than a daily comparison.

### Recommendations for Building Operations

At a higher level than the building monitoring and control recommendations described above, the remote computing system can generate recommendations for overall building operation using a model based on the data obtained from a particular building or from multiple buildings that have building monitoring and control systems like those described herein.

For example, the remote computing system can generate recommendations for improving energy efficiency of a building. Energy efficiency recommendations for a target building can be generated based on past energy utilization of the target building or energy utilizations from other similar buildings, taking into account factors such as usage patterns of the building (e.g., how many people were in the building at different times of day) and weather history at the building's location. The energy efficiency recommendations can be general recommendations about sources of high energy consumption or times of day at which high energy use occurs. For example, the remote computing system determines that threshold amount of a building's energy utilization is driven by the building's cooling system, and therefore provides the general recommendation that the building's energy consumption can be reduced by increasing temperature set points or turning off the cooling system for at least a portion of the day.

In some implementations, the remote computing system can also generate specific recommendations to improve a building's energy efficiency. To reduce an amount of energy used by the building's heating, ventilation, or air conditioning systems, for example, the system can recommend specific set points for specific rooms under various conditions. For example, the system generates a recommendation to set the temperature in a given room to a lower point in the morning because the room typically experiences higher occupancy in the morning, but to increase the set point to a warmer temperature in the afternoon because the room is typically unoccupied in the afternoon. In another example, the remote computing system generates a recommendation to only turn on ventilation in a room when the room is above 20% occupancy because the room is sufficiently large or naturally ventilated to remain comfortable at lower occupancy levels. In still another example, the remote computing system recommends increasing ventilation in one room because doing so allows a neighboring room to remain cool, thus reducing the need to supply air conditioning to the neighboring room.

The remote computing system can further generate recommendations to reduce utility costs for a building. Energy costs may be based both on the amount of power that is used by the building as well as the time of day the power is used. Accordingly, the utility cost reduction recommendations can include general recommendations to reduce power consumption, general recommendations to reduce power consumption during certain hours of the day, or specific recommendations to reduce power consumption or to use power more efficiently across various times of day. In an example, the remote computing system determines that if a particular room is cooled to a lower temperature in the morning (when energy costs are lower), the room will stay relatively cool throughout the day and thus requires less air conditioning in the afternoon when energy costs are higher.

In some implementations, the remote computing system can generate recommendations for types of building equipment to install in a building, either as new equipment being installed in the building for the first time or to replace old or damaged equipment. For example, the remote computing system can recommend a particular HVAC unit to install in a building, considering the building's size, the way the building will be used, the weather at the building's location, or other relevant facts.

### Computer System

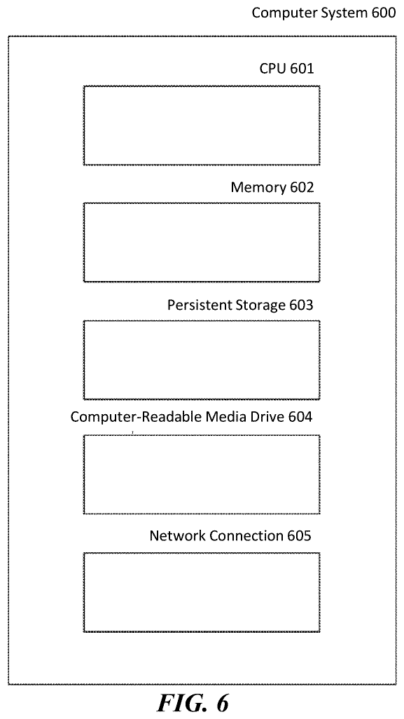

FIG. 6 is a block diagram showing some of the components typically incorporated in at least some of the computer systems and other devices on which the wireless adaptive management system operates.

In various implementations, these computer systems, and other devices 600 can include server computer systems, desktop computer systems, laptop computer systems, netbooks, mobile phones, personal digital assistants, televisions, cameras, automobile computers, electronic media players, etc. In various implementations, the computer systems and devices include zero or more of each of the following: a central processing unit (CPU) 601 for executing computer programs; a computer memory 602 for storing programs and data while they are being used, including the facility and associated data, an operating system including a kernel, and device drivers; a persistent storage device 603, such as a hard drive or flash drive for persistently storing programs and data; computer-readable media drives 604 that are tangible storage means that do not include a transitory, propagating signal, such as a floppy, CD-ROM, or DVD drive, for reading programs and data stored on a computer-readable medium; and a network connection 605 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations and having various components.

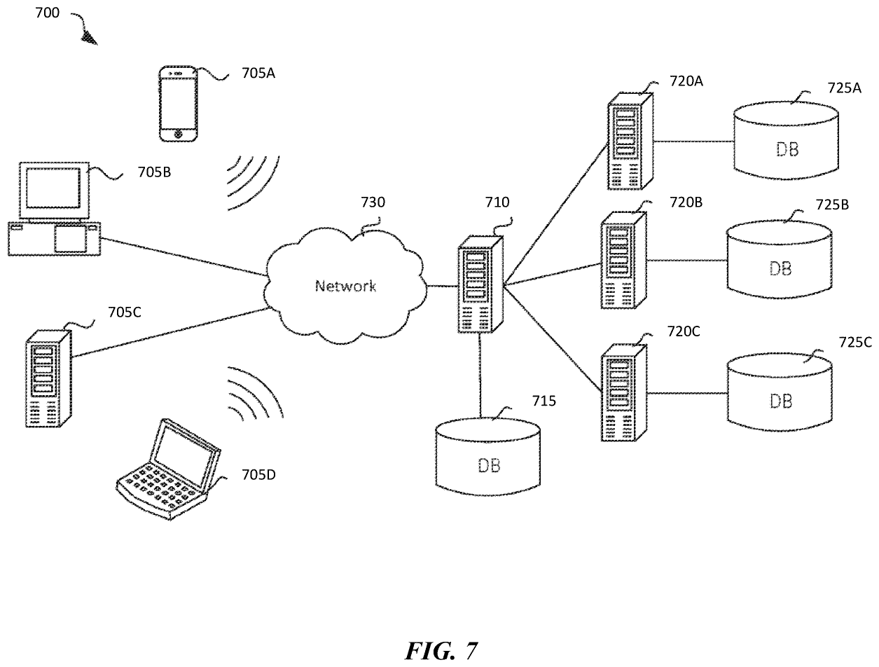

FIG. 7 is a system diagram illustrating an example of a computing environment in which the disclosed system operates in some implementations. In some implementations, environment 700 includes one or more client computing devices 705A-D, examples of which can host the system 700. Client computing devices 705 operate in a networked environment using logical connections through network 730 to one or more remote computers, such as a server computing device.

In some implementations, server 710 is an edge server which receives client requests and coordinates fulfillment of those requests through other servers, such as servers 720A-C. In some implementations, server computing devices 710 and 720 comprise computing systems, such as the system 700. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server or client devices. In some implementations, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information such as home information, recent sales, home attributes, and so on. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN) but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

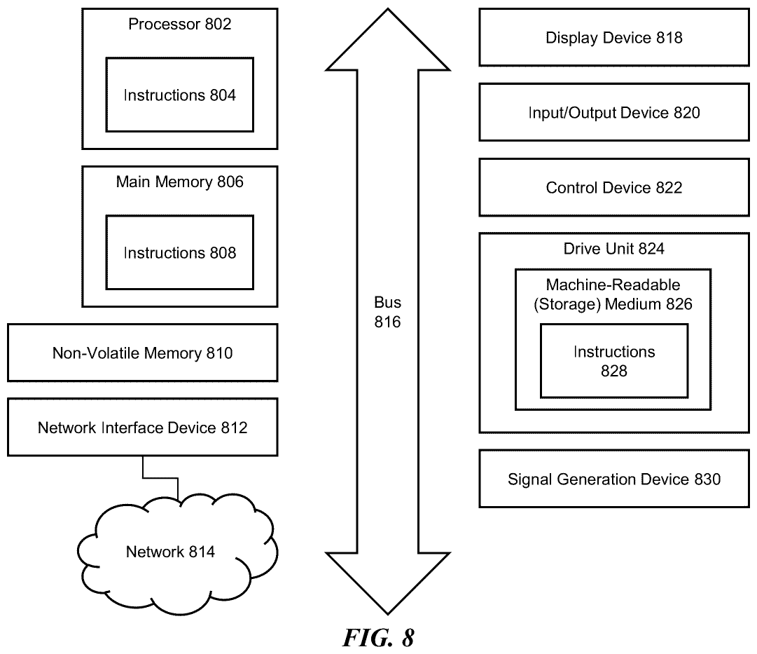

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that can store, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure have their ordinary meanings in the relevant technical art, within the context of the disclosure, and in the specific context where each term is used. A recital of alternative language or synonyms does not exclude the use of other synonyms. Special significance should not be placed upon whether a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any portions of this application. Where context permits, words in the above Detailed Description using the singular or plural number may also include the plural or singular number, respectively. The word “or” in reference to a list of two or more items covers all the following interpretations of the word: any of the items in the list, all the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A modular and distributed wireless monitoring and control system comprising:
a plurality of network nodes, each network node comprising:
a piece of environmental equipment, the piece of environmental equipment configured to change one or more parameters of an environment or of the piece of environmental equipment;
one or more sensors configured to measure the one or more parameters; or
one or more smart adapters coupled to the piece of environmental equipment or at least one of the one or more sensors, wherein each smart adapter of the one or more smart adapters comprises:
at least one hardware processor; and
at least one non-transitory memory storing instructions, which, when executed by the at least one hardware processor, cause the smart adapter to:
receive, from the piece of environmental equipment or the at least one of the one or more sensors, an equipment protocol communication comprising the one or more parameters; and
translate the equipment protocol communication into a format capable of being transmitted via a first communication link; and
one or more gateways in operable communication with the plurality of network nodes,
wherein the operable communication occurs via a first communication link to transmit the one or more parameters from the plurality of network nodes to the one or gateways,
wherein the first communication link comprises a physical layer and a communication protocol associated with the physical layer, and
wherein the one or more gateways are in second operable communication with one or more remote computing systems via a second communication link.

2. The modular and distributed wireless monitoring and control system of claim 1, wherein the physical layer of the first communication link comprises radio signals.

3. The modular and distributed wireless monitoring and control system of claim 2, wherein the radio signals are formatted using chirp pulses to encode the one or more environmental parameters.

4. The modular and distributed wireless monitoring and control system of claim 3, wherein the physical layer of the first communication link comprises long range radio (LoRa).

5. The modular and distributed wireless monitoring and control system of claim 4, wherein the communication protocol comprises a long-range wireless area network (LoRaWAN).

6. The modular and distributed wireless monitoring and control system of claim 1, wherein each node of the plurality of nodes is in operable communication with more than one of the one or more gateways via the first communication link.

7. The modular and distributed wireless monitoring and control system of claim 1, wherein the second communication link comprises Ethernet, satellite, mobile broadband, or Wi-Fi.

8. The modular and distributed wireless monitoring and control system of claim 1, wherein the environment comprises a building, a room within a building, a floor within a building, a building complex, or a neighborhood with multiple buildings or groups of buildings.

9. The modular and distributed wireless monitoring and control system of claim 1, wherein the one or more sensors are located within or connected to the at least one piece of environmental equipment.

10. The modular and distributed wireless monitoring and control system of claim 1, wherein the one or more sensors distributed throughout the environment.

11. The modular and distributed wireless monitoring and control system of claim 1, wherein the one or more sensors comprise temperature sensors, pressure sensors, humidity sensors, carbon dioxide sensors, volatile organic compound sensors, particulate matter sensors, air velocity sensors, accelerometers, or light detectors.

12. The modular and distributed wireless monitoring and control system of claim 1, wherein the one or more smart adapters are physically coupled to the piece of environmental equipment or at least one of the one or more sensors via a wired connection.

13. The modular and distributed wireless monitoring and control system of claim 1, wherein the one or more smart adapters are coupled to the piece of environmental equipment or at least one of the one or more sensors via Bluetooth, Wi-Fi, Zigbee, Thread or ultra-wideband (UWB).

14. The modular and distributed wireless monitoring and control system of claim 1, wherein the smart adapter is further caused to implement one or more control protocols to generate and transmit instructions to the piece of environmental equipment to change one or more parameters of an environment or of the piece of environmental equipment.

15. The modular and distributed wireless monitoring and control system of claim 1, wherein the smart adapter is further caused to intercept and buffer commands received from the one or more remote computing systems.

16. The modular and distributed wireless monitoring and control system of claim 1, further comprising a central controller, the central controller comprising:
at least one hardware processor; and
at least one non-transitory memory storing instructions, which, when executed by the at least one hardware processor, cause the central controller to:
receive or generate instructions to change the one or more parameters;
transmit the instructions at least one of the plurality of nodes.

17. The modular and distributed wireless monitoring and control system of claim 16, wherein the central controller is integrated into the one or more gateways, communicatively coupled to the one or more gateways, or divided between the one or more gateways and/or the one or more remote computing systems.

18. The modular and distributed wireless monitoring and control system of claim 1, wherein each network node further comprises:
at least one hardware processor; and
at least one non-transitory memory storing instructions, which, when executed by the at least one hardware processor, cause the network node to:
receive or generate instructions to change the one or more parameters.

19. A non-transitory, computer-readable storage medium comprising instructions recorded thereon, wherein the instructions when executed by at least one data processor of a system, cause the system to:
receive, from a node of the plurality of nodes, an equipment protocol communication comprising one or more parameters of an environment or of the piece of environmental equipment, wherein the node comprises a piece of environmental equipment;
translate the equipment protocol communication into a format capable of being transmitted via a first communication link; and
transmit, to one or more gateways in operable communication with the computer system via a first communication link, the translated equipment protocol communication,
wherein the first communication link comprises a physical layer and a communication protocol associated with the physical layer,
wherein the one or more gateways are in second operable communication with one or more remote computing systems via a second communication link, and
wherein the system comprises a smart adapter coupled to the piece of environmental equipment.

20. A computer implemented method for wireless monitoring and control of a plurality of nodes in an environment, the computer implemented method comprising:
receiving, by a computer system from a node of the plurality of nodes, an equipment protocol communication comprising one or more parameters of an environment or of the piece of environmental equipment, wherein the node comprises a piece of environmental equipment;
translating, by the computer system, the equipment protocol communication into a format capable of being transmitted via a first communication link; and
transmitting, from the computer system to one or more gateways in operable communication with the computer system via a first communication link, the translated equipment protocol communication,
wherein the first communication link comprises a physical layer and a communication protocol associated with the physical layer,
wherein the one or more gateways are in second operable communication with one or more remote computing systems via a second communication link,
wherein the computer system comprises a smart adapter coupled to the piece of environmental equipment, and
wherein the computer system comprises a processor and a memory.
